(19) United States
(12) Patent Application Publication
(10) Pub. No.: US 2009/0006188 A1
(43) Pub. Date: Jan. 1, 2009

(54) ASSOCIATING AN ACTIVITY WITH AN ONLINE ADVERTISEMENT

(75) Inventors: Shunri Guo, Sammamish, WA (US); Kamal Jain, Bellevue, WA (US); James Russell, Seattle, WA (US); Arun K. Sacheti, Sammamish, WA (US); Bradley W. Ward, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/768,495

(22) Filed: Jun. 26, 2007

(51) Int. Cl. G06Q 30/00

(52) U.S. Cl. 705/14

(57) ABSTRACT

The disclosed subject matter pertains to systems and/or methods that facilitate associating user activity, such as offline user activity, with an online advertisement. An ad link component can receive information associated with online activity and offline activity of a user, online advertisements, and other information, and can analyze such information. The online activity can include viewing, clicking on, pledging interest in, or obtaining a token related to, an online advertisement. The ad link component can employ ad link criteria to determine whether offline user activity, such as a purchase or other desired activity, can be associated with the online advertisement. If the ad link component determines the offline user activity is associated with the online advertisement, an incentive, which can be based on incentive criteria, can be awarded to the user. A distribution component can distribute the incentive to the account of the user.

### BACKGROUND

Computing and network technologies have transformed many aspects of everyday life. Computers have become household staples rather than luxuries, educational tools and/or entertainment centers, and provide individuals and corporations with tools to manage and forecast finances, control operations such as heating, cooling, lighting and security, and store records and images in a permanent and reliable medium. Networking technologies like the Internet provide individuals virtually unlimited access to remote systems, information and associated applications.

As computing and network technologies have evolved and have become more robust, secure and reliable, more consumers, wholesalers, retailers, entrepreneurs, educational institutions and the like are shifting paradigms and are employing the Internet to perform business rather traditional means. For example, retailers often use online advertisements to sell or promote their products and services either through their own web sites, e-mail or other electronic message advertising, and/or advertisements that can appear on web sites, blogs, etc. of third parties.

One of the advantages of online advertisements is that if the purchase or other activity (e.g., free trial of a product, test drive a car) marketed by the advertisement is also done online then the purchase/activity can be associated with the advertisement. Associating an online advertisement with the purchase/activity can have several benefits. For example, the performance of an advertisement can be tracked, future advertisements can be targeted better, the operator or owner of the website or blog that displayed the advertisement can receive fair revenue from an advertisement network, and a user can be offered incentives or a share in the advertisement revenue for taking part in the purchase or activity.

However, when consumers view an online advertisement, the consumers do not always make the purchase or engage in the desired activity marketed by the advertisement while online. Sometimes consumers may view an online advertisement and later go to a retailer located at a physical premises (e.g., department store) to make the purchase or perform the activity. It is desirable to be able to associate purchases made and activities performed by consumers while offline in response to online advertisements.

### SUMMARY

The following presents a simplified summary in order to provide a basic understanding of some aspects of the disclosed subject matter. This summary is not an extensive overview of the disclosed subject matter and is not intended to identify key/critical elements or to delineate the scope of such subject matter. Its sole purpose is to present some concepts in a simplified form as a prelude to the more detailed description that is presented later.

Systems and/or methods of associating a purchase or an activity of a user (e.g., user and/or other entity) with an online advertisement are presented. In accordance with one aspect of the disclosed subject matter, an ad link component can be employed to monitor and evaluate online activity of a user, while a user is logged on to, and authenticated by, a network for which the user can be pre-registered. In accordance with various aspects of the disclosed subject matter, the user can be logged on to the network and can view an online advertisement and/or can take some other action (e.g., mouse click on an object in an online advertisement, pledge interest in an online advertisement, generate a token number) with regard to the online advertisement. Such online activity can be stored in an account associated with the user.

If the user subsequently goes to a merchant that has the item, product, and/or service marketed by the online advertisement and the user completes a purchase or other activity (e.g., taking part in a free trial of a product, test driving a car, etc.) of the item, product, and/or service, information regarding the purchase or other activity can be documented or logged in the account of the user. Such user activity information can be evaluated by the ad link component to determine whether such purchase or activity meet certain ad link criteria so as to be able to associate the purchase or other activity with the online advertisement. In accordance with an aspect of the disclosed subject matter, the ad link criteria can include that the interest in or response (e.g., view, mouse click, pledge, token) to the online advertisement occur at a time prior to the time of the purchase or other desired activity. Another ad link criteria can include that the purchase or other desired activity occur within a predetermined period of time after the interest or response by the user to the online advertisement, and/or by a date certain.

If the ad link component determines that such purchase/activity can be associated with the online advertisement, the user can be awarded an incentive (e.g., money, points, coupons, products, services, etc.). The type and/or amount of incentive can be based on predetermined incentive criteria. The appropriate incentive can be deposited into the account of the user and/or can be provided to the user in virtually any other suitable manner (e.g., provided to the user by a merchant). If the ad link component determines that the purchase/activity does not meet the ad link criteria, then a determination can be made that the purchase/activity is not associated with the online advertisement and no incentive is awarded to the user.

To the accomplishment of the foregoing and related ends, certain illustrative aspects are described herein in connection with the following description and the annexed drawings. These aspects are indicative of various ways in which the disclosed subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

FIG. 1 illustrates a block diagram of a system that facilitates association of an online advertisement with user activity in accordance with an aspect of the disclosed subject matter.

FIG. 2 illustrates a block diagram of another system that facilitates association of an online advertisement with user activity in accordance with an aspect of the disclosed subject matter.

FIG. 3 illustrates a block diagram of a system that facilitates communication with a community network to facilitate a determination regarding whether user activity can be associated with an online advertisement in accordance with an aspect of the disclosed subject matter.

FIG. 4 illustrates a block diagram of a system that employs intelligence to facilitate a determination regarding whether user activity can be associated with an online advertisement in accordance with an aspect of the disclosed subject matter

FIG. 5 is a representative flow diagram illustrating a methodology that facilitates linking user activity with an online advertisement in accordance with an aspect of the disclosed subject matter.

FIG. 6 is a representative flow diagram depicting a methodology that facilitates associating user activity with an online advertisement in accordance with an embodiment of the disclosed subject matter.

FIG. 7 is a representative flow diagram illustrating a methodology that can utilize viewing information to facilitate associating user activity with an online advertisement in accordance with another embodiment of the disclosed subject matter.

FIG. 8 is a representative flow diagram that illustrates a methodology that can utilize viewing information and/or token information to facilitate associating user activity with an online advertisement in accordance with yet another embodiment of the disclosed subject matter.

FIG. 9 is a representative flow diagram that depicts a methodology that can utilize pledge information to facilitate associating user activity with an online advertisement in accordance with still another embodiment of the disclosed subject matter.

FIG. 10 is a representative flow diagram illustrating a methodology that can utilize click information and/or token information to facilitate associating user activity with an online advertisement in accordance with another embodiment of the disclosed subject matter.

FIG. 11 is a representative flow diagram illustrating another methodology that can utilize click information and/or token information to facilitate associating user activity with an online advertisement in accordance with still another embodiment of the disclosed subject matter.

FIG. 12 is a representative flow diagram illustrating yet another methodology that can utilize click information and/or token information to facilitate associating user activity with an online advertisement in accordance with another embodiment of the disclosed subject matter.

FIG. 13 is a schematic block diagram illustrating a suitable operating environment.

FIG. 14 is a schematic block diagram of a sample-computing environment.

### DETAILED DESCRIPTION

The various aspects of the disclosed subject matter are now described with reference to the annexed drawings, wherein like numerals refer to like or corresponding elements throughout. It should be understood, however, that the drawings and detailed description relating thereto are not intended to limit the disclosed subject matter to the particular form disclosed. Rather, the intention is to cover all modifications, equivalents, and alternatives falling within the spirit and scope of the disclosed subject matter.

As used in this application, the terms “component,” “system,” “store,” “interface,” and the like are intended to refer to a computer-related entity, either hardware, a combination of hardware and software, software, software in execution, and/or firmware. For example, a component may be, but is not limited to being, a process running on a processor, a processor, an object, an instance, an executable, a thread of execution, a program and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over the other aspects or designs.

Furthermore, all or portions of the subject innovation may be implemented as a method, apparatus, or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device, carrier, or media. For example, computer readable media can include but is not limited to magnetic storage devices (e.g., hard disk, floppy disk, magnetic strips . . . ) optical disks (e.g., compact disk (CD), digital versatile disk (DVD . . . )), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the disclosed subject matter.

Online advertising has become popular for a variety of reasons. Retailers and/or other entities often use online advertisements to sell or promote products and/or services through web sites, blogs, e-mail, and/or other electronic communication means. When a user sees an online advertisement, for example, on a web site of a merchant, and the user purchases the product/service in the advertisement, the merchant can associate the online advertisement with the purchase by the user. However, when the user sees an online advertisement, but does not make the purchase while online, instead making the purchase at the store of a merchant, for example, it can be desirable to be able to associate such purchase with the online advertisement. Being able to associate offline user activity (e.g., purchases, etc.) with an online advertisement can have many benefits, as such association can facilitate tracking the performance of the online advertisement, can facilitate targeting future online advertisements, can enable the entity that displayed the online advertisement (e.g., on the web site of the entity) to gain advertisement revenue from the advertiser network (also referred to herein as “ad network”), and/or can enable the user to be offered incentives or a share in the advertisement revenue.

Systems and/or methods that facilitate associating user activity with an online advertisement(s) are presented. The disclosed subject matter can include an ad link component that can receive information associated with user activity (e.g., online user activity, offline user activity) and online advertisements, can analyze such information, and can determine whether the offline user activity can be associated with an online advertisement(s) based on ad link criteria. Further, the ad link component can employ incentive criteria to facilitate determining a type and/or amount of incentive to be awarded to a user who performs a desired activity associated with an online advertisement. The ad link component can be associated with a distribution component that can facilitate depositing an appropriate incentive into an account of the user.

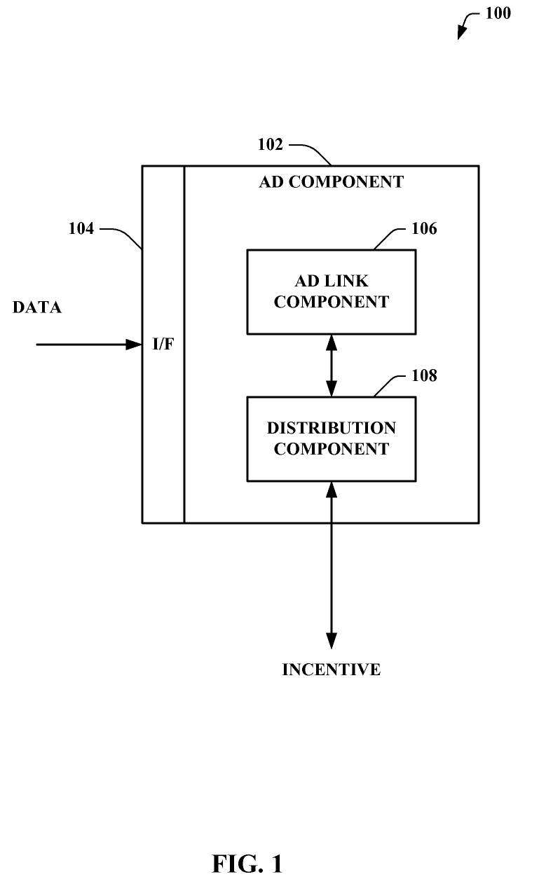

Turning now to FIG. 1, an illustration of a system 100 that facilitates associating activity of a user with an online advertisement is depicted. In accordance with one aspect of the disclosed subject matter, system 100 can include an ad component 102 that can receive data via an interface component 104 (e.g., discussed infra) to facilitate determining whether activity by a user, such as offline activity (e.g., activity that can occur while not online with and/or communicating via a computer), can be associated with an online advertisement, which can be associated with a community network that can include an ad network.

The ad component 102 can receive data associated with one or more online advertisements, where an online advertisement can include an advertisement that can be located on a web site, in a web page, in a blog, in an e-mail, in an instant message, and/or in any other electronic communication associated with the Internet or other communication network, for example. Such data can include, for example, merchant information, ad link criteria (described infra), incentive criteria (described infra), information regarding one or more activities (e.g., purchase, other desired non-purchase activity) that are desired to be performed in response to the online advertisement, and/or other information. A user viewing such online advertisement can perceive the information relating to the incentive.

The ad component 102 also can receive data respectively associated with one or more users (e.g., persons, clients, and/or entities) where each user can be identified via an account for which each user can register. The user can log into the account by providing authentication information to authenticate (e.g., verify) the user, to facilitate identification of the user by a community network that can include an ad network. The user account can be associated with the community network. The data received can include information associated with online activity of a user as well as offline activity of a user.

Online activity showing the interest or response of the user with regard to an online advertisement can include viewing the online advertisement(s), clicking (e.g., mouse, keystroke, voice command, etc.) on an object associated with the online advertisement(s), and/or pledging an interest in the online advertisement(s), where such online advertisement(s) can be located on web site, in a web page, in a blog, e-mail, instant message, and/or other online electronic communication. Further, online activity of a user showing an interest or response can further include receiving a token (e.g., token number) associated with an online advertisement(s) that can be generated by an ad network and/or an entity affiliated with the ad network.

With regard to the offline activity of the user, the data can include information regarding virtually any activity that an advertiser and/or advertising network desires to be performed by a user based on the online advertisement. For example, the activity can be a purchase, sampling a product and/or service associated with the advertisement (e.g., test drive a car, free trial of a product or service), registering for a product or service (whether free or as a purchase), filling out a form associated with the online advertisement, providing a review or comments regarding a product and/or service associated with the online advertisement to the advertiser and/or ad network, etc. Information (e.g., data) regarding such activity of a user can be received by the ad network component 102 and can be stored in a data store (not shown), for example. The ad network component 102 can evaluate such information as it is received and/or can retrieve such information from the data store and evaluate such information.

The ad component 102 can include an ad link component 106 that can facilitate making a determination regarding whether an offline activity (e.g., purchase, test drive, etc.) of a user can be associated with an online advertisement. The ad link component 106 can analyze and evaluate the online activity of the user with regard to the online advertisement and the offline activity of the user with regard to the online advertisement, and/or the product and/or service marketed by the online advertisement, and can determine whether the offline activity can be associated with, linked with, and/or in response to, the online advertisement.

Once the user has indicated an interest in the online advertisement and/or the item or service marketed therein, the ad link component 106 can monitor the actions of the user to determine whether the user completes the activity (e.g., purchase, non-purchase activity, transaction) desired by the ad network and/or an entity (e.g., merchant, advertiser) associated therewith. The activity can be an offline activity, as described herein, for example. If the ad link component 106 receives information regarding user activity, the ad link component 106 can facilitate storing such user activity information in the account of the user.

The user activity information of the user received by the ad link component 106 can be utilized, along with other information (e.g., online activity information) associated with the account of the user, to facilitate determining whether the offline user activity can be associated with the online advertisement.

The ad link component 106 can employ predetermined ad link criteria to determine whether the offline activity of the user can be associated with the online advertisement. For example, one ad link criteria can be that the desired user activity occur after the time the user indicates an interest in the online advertisement and/or otherwise responds to the online advertisement. If the interest in, or response to, the online advertisement was not made prior to the user activity, the ad link component 106 can determine that the user activity is not associated with the online advertisement, since the ad link component 106 can infer that the user had not observed the online advertisement prior to the activity of the user

Another ad link criteria can be that the desired user activity occur, and/or that information regarding such desired user activity be received by the ad component 102, within a predetermined period of time (e.g., one week, 30 days, 60 days, etc.) after the user expresses an interest and/or otherwise responds to the online advertisement, or by a predetermined date certain. User activity occurring, and/or information regarding user activity received by the ad component 102, outside of such period of time can be deemed by the ad link component 106 as not being associated with the online advertisement.

If the ad link component 106 determines that the ad link criteria are satisfied, the ad link component 106 can determine that the user activity can be considered to have been activity taken in response to the online advertisement, and the ad link component 106 can determine that the user activity can be associated with or linked to the online advertisement. In such instance, the ad link component 106 can provide the user with an incentive for performing the desired offline activity associated with the online advertisement. The incentive can be in virtually any form, such as, for example, monetary, points, coupons, awards, products, services, and/or other compensation or remuneration.

The ad link component 106 can analyze various factors (e.g., incentive criteria) to determine the amount and/or type of incentive that can be provided to a user. The various factors can include, for example, the length of time between the user expressing interest in or responding to the online advertisement and completion, by the user, of the activity desired by the ad network; and/or the type of activity performed by the user. For example, the ad link component 106 can award a higher valued incentive (e.g., in amount and/or type) if a desired user activity is performed within a certain period of time, which can be a shorter period than the predetermined period of time associated with the incentive criteria. Also, one type of activity, such as a purchase, can result in a higher valued incentive being awarded to a user than the incentive awarded for another type of activity, such as a sampling or free trial of a product or service, for example.

Ad network component 102 can further include a distribution component 108 that can facilitate distributing the incentive to the user. The distribution component 108 can distribute the appropriate incentive once the ad link component 106 has determined the amount (e.g., 1 point, 5 points, etc.) and/or type (e.g., money, points, etc.) of incentive to be awarded. The incentive can be provided to the user by depositing such incentive into the account of the user. Once the incentive is deposited to the account of the user, it can be provided to the user in virtually any suitable manner, such as allowing the user to retrieve the incentive from the account of the user, directing a merchant to provide the incentive to the user, facilitating the mailing of such incentive to the user, etc.

In accordance with one embodiment of the disclosed subject matter, the ad component 102 can facilitate determining whether user activity can be associated with an online advertisement based in part on online viewing activity of the user. A user can indicate interest in or respond to the online advertisement by viewing the advertisement while authenticated and/or identified by a community network that can be associated with the ad component 102, for example. While logged in to the community network, if the user views an online advertisement on a web page, web site, blog, and/or other electronic communication, an ad-impression of the online advertisement can be stored in a browser cookie and such information can be stored in the account of the user.

If the user performs an activity related to the online advertisement desired by the ad network (e.g., advertiser), the merchant can request the account information of the user, and enter information regarding the user activity which can be received by the ad component 102 and documented in the account of the user. The ad link component 106 can analyze the online activity (e.g., viewing of online advertisement) and offline user activity to determine whether the ad link criteria have been met. If the ad link criteria have been met, the ad link component 106 can associate the offline user activity with the online advertisement. For example, if an ad link criteria is that the user view the online advertisement before the offline user activity is performed in order for the user to be awarded an incentive, the ad link component 106 can determine whether such criteria is satisfied and, if so, an incentive can be awarded to the user. The ad link component 106 can also determine the amount of incentive to be awarded, and the distribution component 108 can facilitate depositing such incentive into the account of the user.

In accordance with still another embodiment of the disclosed subject matter, the ad component 102 can facilitate determining whether user activity can be associated with an online advertisement based in part on online viewing activity of the user and/or a user expressing interest in the online advertisement by obtaining a token associated therewith. While authenticated and/or identified by the community network, a user can view an online advertisement, and if interested, the user can request a token from the ad component 102. The ad link component 106 can facilitate generating a token, which the user can receive (e.g., print out the token). The token can include token identification information, such as a number or other information that can identify the online advertisement, the time the token was generated, the user, and/or the account associated with the user, for example.

When the user performs the activity desired by the ad network, the user can present the token to the merchant. The user can present the token to the merchant, and, if the user has completed the desired activity, the merchant can present the token (e.g., input token information) to the ad component 102, which can receive and store such token information. When presenting the token, the merchant can request user account information from the user to provide to the ad network component 102 to facilitate presenting the token information, although the token may include such user account information, and providing the token information may identify the user and the user account. The presence of the token information can indicate that the user has viewed the online advertisement.

The ad link component 106 can analyze the online activity information (e.g., token information) and offline user activity information to determine whether the incentive criteria have been met. If the ad link criteria has been met, the ad link component 106 can associate the offline user activity with the online advertisement. For example, one criteria can be that the user see the online advertisement prior to the desired activity is performed. Since the user has presented the token to the merchant, the token can indicate that the user has seen the online advertisement. By performing the desired activity, the user has satisfied the incentive criteria, so long as any other incentive criteria are satisfied as well. The ad link component 106 can also determine the amount of incentive to be awarded, and the distribution component 108 can facilitate depositing such incentive into the account of the user.

In accordance with yet another embodiment of the disclosed subject matter, the ad component 102 can facilitate determining whether user activity can be associated with an online advertisement based in part on the user pledging an interest in the online advertisement. While authenticated/or identified by the community network, the user can view an online advertisement and can then pledge an interest in the online advertisement and/or the product or service marketed therein. The user can log in to his/her account associated with the ad component 102. If the user is interested in the online advertisement, the user can pledge an interest in such online advertisement. Information regarding the pledge of the user can be recorded or stored in the account of the user.

If the user pledged an interest in the online advertisement, upon completing the desired user activity, the user can provide the merchant the account information of the user, and the merchant can provide such user activity information to the ad component 102, which can receive such information, and the pledge can be indicated as complete.

The ad link component 106 can analyze the online activity information (e.g., pledge information) and offline user activity information to determine whether the incentive criteria have been met. If the ad link criteria has been met, the ad link component 106 can associate the offline user activity with the online advertisement. For example, if an ad link criteria is that the user pledge an interest in the online advertisement before the offline user activity is performed in order for the user to be awarded an incentive, the ad link component 106 can determine whether such criteria is satisfied and, if so, an incentive can be awarded to the user. The ad link component 106 can also determine the amount of incentive to be awarded, and the distribution component 108 can facilitate depositing such incentive into the account of the user.

In accordance with another embodiment of the disclosed subject matter, the ad component 102 can facilitate determining whether user activity can be associated with an online advertisement based in part on click information of the user with regard to the online advertisement and/or token information. While logged into the community network, the user can see an online advertisement. The user can indicate interest in or respond to the online advertisement by manipulating an object that can be included in the online advertisement. Such manipulation can include, for example, clicking (e.g., mouse click, keystroke, voice command, etc.) on the object. By manipulating the object, the user can thereby indicate an interest in the online advertisement and/or the product or service marketed therein. The manipulation and/or click information of the user can be stored in the account of the user.

If the user goes to a merchant and performs an activity desired by the ad network with respect to the online advertisement, the merchant can present the user with a token, which can be generated by the ad component 102 and/or by the merchant in cooperation with the ad component 102 and/or ad network. The token (e.g., token information) can be included as part of a receipt, for example, and can include information such as the type of activity performed by the user, the time the activity was performed, an amount of incentive that can be awarded to the user, and/or user account information. The user can log into his account and can enter the token information through his/her account.

The ad link component 106 can analyze the online activity information (e.g., click information, token information) and offline user activity information, including the token information, to determine whether the ad link criteria has been met. If the ad link criteria have been met, the ad link component 106 can associate the offline user activity with the online advertisement. For example, an ad link criteria can be that the user click on the online advertisement before the offline user activity is performed and/or a token generated and given to the user in order for the user to be awarded an incentive. The ad link component 106 can determine whether such criteria (and other criteria, if any) is satisfied and, if so, the user can be awarded an incentive. The ad link component 106 can also determine the amount of incentive to be awarded, and the distribution component 108 can facilitate depositing such incentive into the account of the user.

In accordance with still another embodiment of the disclosed subject matter, the ad component 102 can facilitate determining whether user activity can be associated with an online advertisement based in part on click information of the user and/or a token that can be activated. While authenticated and/or identified by the community network, the user can see an online advertisement. The user can indicate interest in or respond to the online advertisement by manipulating an object that can be included in the online advertisement. Such manipulation can include, for example, clicking on the object, keystroke associated with the object, and/or voice command of user to take action with regard to the object. By manipulating the object, the user can thereby indicate an interest in the online advertisement and/or the product or service marketed therein. The manipulation and/or click information of the user can be stored in the account of the user.

If the user goes to a merchant and performs an activity desired by the ad network with respect to the online advertisement, the merchant can activate a pre-generated token (e.g., card with a magnetic stripe), which can thereby indicate that user has completed the activity desired by the ad network, and can further provide additional information such as the time the activation was performed, the type of activity that was performed by the user, and/or the amount of incentive that can be awarded to the user, for example. The pre-generated token can be generated by the ad component 102 and/or an affiliate of the ad network, for example. The activated pre-generated token can be provided to the user. The user can log into his account and can enter (e.g., input via keystroke/mouse, scan token, etc.) the token information through his/her account.

The ad link component 106 can analyze the online activity information (e.g., click information, token information) and offline user activity information, including the token information, to determine whether the ad link criteria have been met. If the ad link criteria have been met, the ad link component 106 can associate the offline user activity with the online advertisement. For example, an ad link criteria can include that the user click on the online advertisement before the offline user activity is performed and the token is activated in order for the user to be awarded an incentive. The ad link component 106 can determine whether such criteria (and other criteria, if any) is satisfied and, if so, the user can be awarded an incentive. The ad link component 106 can also determine the amount and/or type of incentive to be awarded, and the distribution component 108 can facilitate depositing such incentive into the account of the user.

In yet another embodiment of the disclosed subject matter, the ad component 102 can facilitate determining whether user activity can be associated with an online advertisement based in part on token information and/or click information of the user with regard to the online advertisement. The token can be included in a product (e.g., token placed inside cereal box), mailed to the user (e.g., mass mailing), and/or electronically mailed (e.g., e-mail, instant message) to the user. If the user purchases or otherwise obtains the product, and/or receives the electronic mail, the user can receive the token. The token can be generated by the ad network or an entity (e.g., affiliate, third-party network, agent) associated therewith, for example. Where the user has received the token by means other than by performing the desired activity, such as by a mailing or electronic communication, the user can perform the activity desired by the ad network, and can obtain information (e.g., receipt) that can verify that the desired activity was completed.

The user can log into his/her account that can be associated with the community network, and can locate the online advertisement associated with the token. The user can manipulate (e.g., click on, keystroke on, etc.) the online advertisement, or an object contained therein, to redeem the token. The user can enter (e.g., input via keystroke/mouse, scan token, etc.) the information associated with the token. Where the user obtained the token by means other than by performing the desired activity, the user can also input activity information verifying that the desired activity was completed.

The ad link component 106 can analyze the online activity information (e.g., click information, token information) and offline user activity information, including the token information, to determine whether the ad link criteria have been met. If the ad link criteria have been met, the ad link component 106 can associate the offline user activity with the online advertisement. For example, an ad link criteria can be that the user perform the desired activity, obtain a token associated therewith, and click on the online advertisement associated therewith in order for the user to be awarded an incentive. The ad link component 106 can determine whether such criteria (and other criteria, if any) has been satisfied, and if so, an incentive can be awarded to the user. The ad link component 106 can also determine the amount of incentive to be awarded, and the distribution component 108 can facilitate depositing such incentive into the account of the user.

Turning back to interface 104, the system 100 can include any suitable and/or necessary interface component 104 (also herein referred to as “interface 104”), which can provide various adapters, connectors, channels, communication paths, etc. to integrate the ad component 102 into virtually any operating and/or database system(s) and/or with one another system(s). In addition, the interface component 104 can provide various adapters, connectors, channels, communication paths, etc., that can provide for interaction with the ad component 102, the distribution assessment 108, and/or any other component, data and the like associated with the system 100.

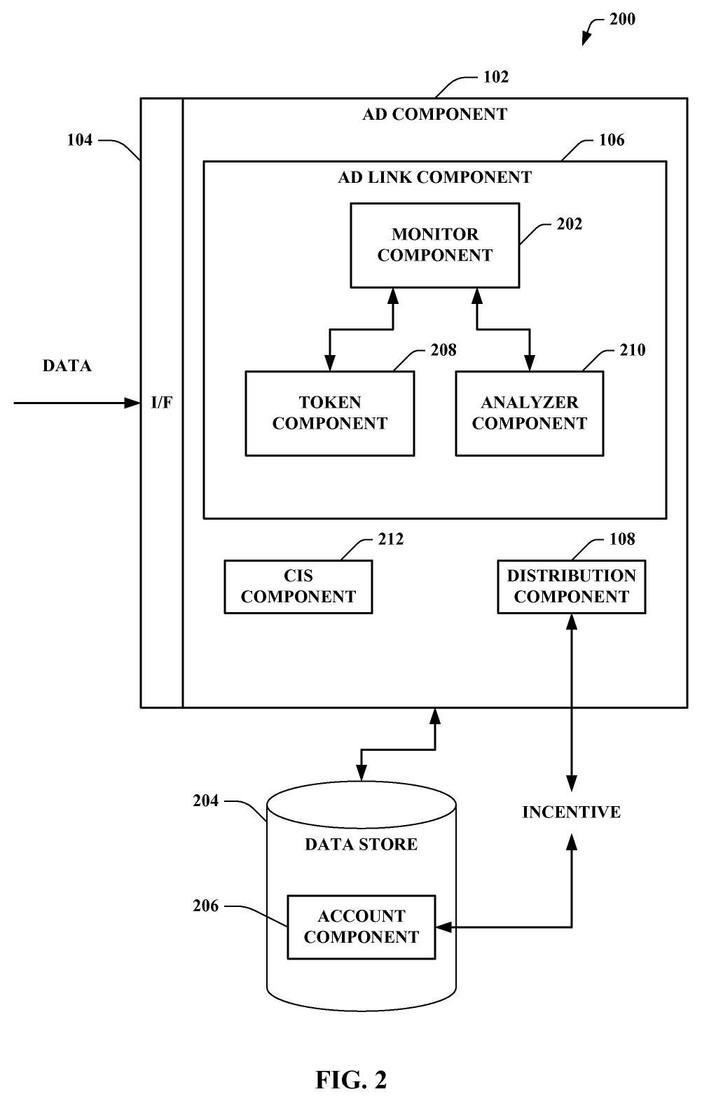

Referring to FIG. 2, a system 200 that facilitates associating or linking user activity with an online advertisement is illustrated. System 200 can facilitate determining whether user activity, such as offline activity, can be associated with an online advertisement. System 200 can include an ad component 102 that can receive information, via interface 104, regarding online activity of a user as well as other user activity (e.g., offline user activity) of a user and can determine whether a particular activity(ies) of a user is associated with, linked with, and/or in response to an online advertisement. The online user activity can include those online user activities described herein, for example, with regard to system 100. The offline user activities can include those offline user activities described herein, for example, with regard to system 100.

The ad component 102 can also receive information associated with one or more online advertisements via interface 104. Such online advertisement information can include the online advertisement information described herein, for example, with regard to system 100.

Ad component 102 can include an ad link component 106 that can facilitate determining whether offline user activity can be associated with an online advertisement. The ad link component 106 can function as described herein, for example, in system 100. The ad link component 106 can include a monitor component 202 that can monitor the online activity of users, particularly with regard to online activity associated with online advertisements. The monitor component 202 can also monitor offline activity of users, such as information regarding such offline user activity that can observed from communication with merchants and/or information regarding such offline activity that can be provided by the users when online, for example. The monitor component 202 can receive information regarding all such online activity and offline activity of users. Further, the monitor component 202 can also receive information associated with online advertisements.

The ad component 102 can be associated with a data store 204 that can store any suitable data (e.g., information) related to the ad component 102, including, for example, information associated with the online activity and offline activity of users in the network, user account information, information associated with merchants disposed in the network, and/or information associated with online advertisements. The data store 204 also can facilitate storing information associated with a user in a user account 206 associated with the user that can be stored in data store 204.

It is to be appreciated that the data store 204 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 204 of the subject systems and methods is intended to comprise, without being limited to, these and any other suitable types of memory. In addition, it is to be appreciated that the data store 204 can be a server, a database, a hard drive, and the like.

The ad component 102 can also include a token component 208 that can facilitate generating one or more tokens that can be utilized to facilitate determining whether user activity, such as offline user activity, can be associated with an online advertisement(s). A token can include token identification information, such as a number or other information that can identify the online advertisement, the time the token was generated, the user, and/or an the account associated with the user, for example. Where the token is generated via a merchant, the token can further include information such as information indicating the user completed a desired activity, the type of activity performed by the user, the time the activity was performed, the time the activation was performed (when the token is a pre-generated token that can be activated), and/or an amount of incentive that can be awarded to the user, for example.

The token component 208 can facilitate generating a token by enabling a user to generate (e.g., print) the token and/or enabling a merchant to generate a token (e.g., receipt). Further, the token component 208 can facilitate generating the token and/or can enable an ad network to generate tokens, and can receive information associated with the tokens to facilitate identifying a respective token.

The ad component 102 can further include an analyzer component 210 that can receive information from the monitor component 202 and/or retrieve information from the data store 204 and/or the user accounts 206. The analyzer component 210 can analyze the user information, such as online and offline activities of a user, and compare it with online advertisement information and/or other information (e.g., merchant information). The analyzer component 210 can employ criteria, such as ad link criteria, to facilitate determining whether activity of a user can be associated with an online advertisement. Further, the analyzer component 210 can use incentive criteria to facilitate determining a type and/or amount of incentive to be awarded to a user. The ad link criteria and/or incentive criteria can be such ad link criteria and/or incentive criteria described more fully herein, for example, with regard to system 100.

Ad component 102 can also include a common identity service (CIS) component 212 that can receive authentication information from one or more users to identify a particular user and authenticate (e.g., verify) a particular user, so that the identity of a particular user can be reasonably known by the ad component 102. The CIS component 212 can request a user to authenticate, for example, when the user attempts to manipulate (e.g., mouse click, keystroke, voice command, etc.) an advertisement, an object associated with an advertisement, and/or associated controls that can be associated with an advertisement for a product or service, primary actions, community actions, syndication actions, etc.

The ad component 102 can facilitate storing information in user account 206 that can be associated with a respective user, as the CIS component 212 can identify the respective user, so that the data store 204, the ad component 102, and other components can know which user account 206 is to be accessed when sending data to or receiving data from data store 204, and/or associating data with the user account 206 when data is stored in data store 204.

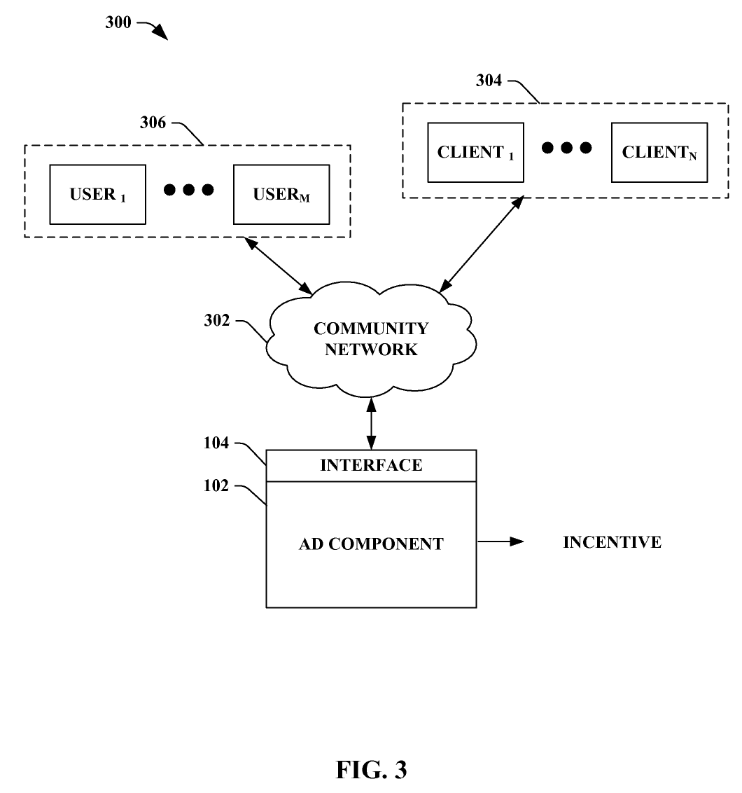

Turning to FIG. 3, depicted is a system 300 that facilitates communication with a community network to facilitate determining whether user activity can be associated with an online advertisement in accordance with the disclosed subject matter. The system 300 can include the ad component 102 that can facilitate determining whether user activity can be associated with an online advertisement based at least in part upon an online user activity, offline user activity, and/or most any suitable data received by the interface 104.

For instance, the ad component 102 can determine whether user activity can be associated with an online advertisement(s) based upon received data, including, but not limited to, data associated with online activity, information associated with offline user activity, online advertisements, user account activity across a disparate network, activity across a network, products and/or services purchased, user accounts, etc. Further, based upon the received data, the ad component 102 can facilitate determining an incentive to award the user, if the user activity is associated with the online advertisement.

Furthermore, the ad component 102 can interact with a community network 302. Also, the community network 302 can include an ad network. Further, the community network 302 can include most any suitable number of clients 304 (e.g., merchants, retailers, wholesalers, advertisers, advertising agents, etc.), such as client₁ to client_{N}, where N is a positive integer, that can be associated with the community network 302 associated an ad network. The client(s) can be merchant(s), advertiser(s), retailer(s), wholesaler(s), etc. that can facilitate generation of online advertisements, and/or products, services, and/or other commerce. The community network 302 also can include most any suitable number of users 306, such as user₁ to user_{M}, where M is a positive integer. It is to be appreciated that ad component 102 can facilitate making a determination regarding whether user activity associated with a respective user can be associated with an online advertisement.

In one example, the community network 302 can be a network associated with commerce and/or transactions related to commerce such as buying an item or a product, selling an item or a product, buying a portion of a service, selling a portion of a service, etc. In other words, the ad component 102 can receive and evaluate data from the community network 302 in order to facilitate determining whether activity of a user 306 can be associated with an online advertisement. In particular, the ad component 102 can provide incentives to users 306 based in part on the data evaluation of data obtained from the community network 302.

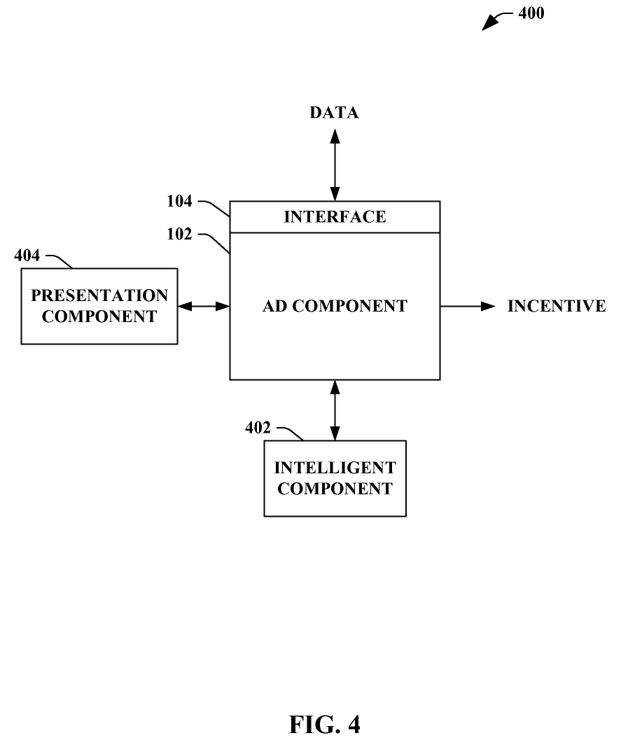

FIG. 4 illustrates a system 400 that employs intelligence to facilitate determining whether user activity can be associated with an online advertisement in accordance with the disclosed subject matter. The system 400 can include the ad component 102, and the interface 104, wherein it is to be appreciated that the ad component 102, and interface 104 can be substantially similar to respective components and interfaces described in previous figures. The system 400 further includes an intelligent component 402. The intelligent component 402 can be utilized by the ad component 102 to facilitate a determination as to whether an offline activity of a user can be associated with the online activity of a user with regard to an online advertisement. For example, the intelligent component 402 can infer whether and when online activity of a user relating to an online advertisement occurred, whether and when offline activity of the user relating to an online advertisement occurred, whether user offline activity can be associated with an online advertisement, the type and/or amount of incentive that can be awarded to a user, etc.

It is to be understood that the intelligent component 402 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the disclosed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

The ad component 102 can further utilize a presentation component 404 that provides various types of user interfaces to facilitate interaction between a user and any component coupled to the ad component 102. As depicted, the presentation component 404 is a separate entity that can be utilized with the ad component 102. However, it is to be appreciated that the presentation component 404 and/or similar view components can be incorporated into the ad component 102 and/or a stand-alone unit. The presentation component 404 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the ad component 102.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

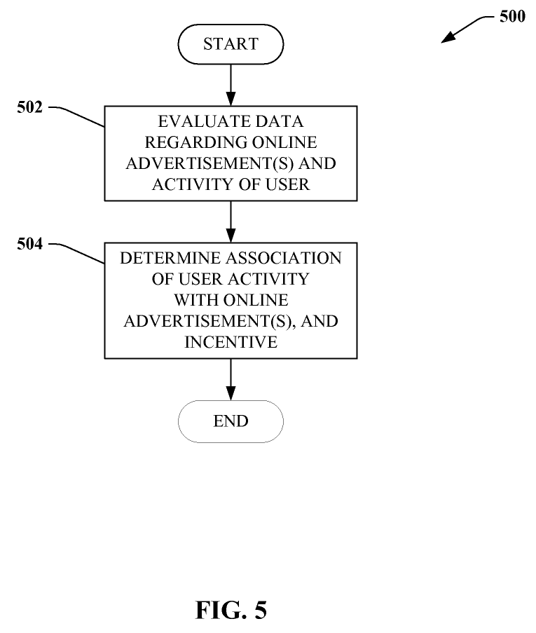

FIGS. 5-12 illustrate methodologies and/or flow diagrams in accordance with the disclosed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 5, depicted is a method that can facilitate associating user activity with an online advertisement in accordance with an aspect of the disclosed subject matter. In accordance with methodology 500, data associated with online activity of a user, such as online activity associated with an online advertisement, and/or user activity information (e.g., offline user activity) can be utilized to facilitate determining whether an activity performed by a user can be associated with an online advertisement. At 502, data related to the online activity of a user with regard to one or more online advertisements and activity (e.g., offline user activity) of the user can be evaluated, for example, by an ad component (e.g., 102) that can be associated with an ad network. For example, the online activity of the user can include viewing an online advertisement(s), clicking (e.g., mouse, keystroke) on an object associated with the online advertisement(s), and/or pledging an interest in the online advertisement(s), where such online advertisement(s) can be located on web site, in a web page, in a blog, e-mail, instant message, and/or other online electronic communication. Further, online activity of a user can include receiving a token (e.g., token number) associated with an online advertisement(s) that can be generated by an ad network and/or an entity affiliated with the ad network.

Information associated with such online activity of a user with regard to online advertisements can be received by the ad component 102 and stored in a data store 204, for example. The ad component 102 can retrieve such data from the data store 204 and evaluate such data.

With regard to the offline activity of the user, the data can include virtually any activity that an advertiser and/or advertising network desires to be performed by a user based on the online advertisement. For example, the activity can be a purchase, sampling a product and/or service associated with the advertisement (e.g., test drive a car, free trial of a product or service), registering for a product or service (whether free or as a purchase), filling out a form associated with the advertisement, providing a review or comments regarding a product and/or service associated with the advertisement to the advertiser and/or ad network, etc. Information regarding such activity of a user can be received by the ad network and stored in a data store, for example. The ad component 102 can retrieve such data from the data store 204 and evaluate such data.

At 504, a determination can be made regarding whether the user activity can be associated with the online advertisement and regarding an incentive that can be awarded if the user activity and online advertisement can be associated with each other. With regard to determining if there is an association or link between the user activity and an online advertisement, the determination can include determining whether the user offline activity (e.g., purchase or other desired activity) occurred after the user online activity (e.g., viewing, clicking on, pledging interest in, printing token related to, the online advertisement) with regard to the online advertisement; determining whether the offline user activity occurred within a predetermined period of time (e.g., one week, 30 days, 60 days, etc.) after the user online activity with regard to the online advertisement, and/or a date certain; and/or determining whether other ad link criteria are satisfied.

For example, if the online user activity related to the online advertisement was not made prior to the user offline activity, the user offline activity can be deemed as not being associated with the online advertisement, since the ad component 102 can infer and/or determine that the user had not observed the online advertisement prior to the offline activity of the user and/or was not engaging in the offline activity in response to the online advertisement. Further, if the offline user activity was made outside of the predetermined period of time after the user online activity with regard to the online advertisement, or beyond a date certain, the offline activity can be deemed as not being associated with the online advertisement.

In contrast, the offline user activity can be associated with the online activity, for example, if the user offline activity occurs after the time of the response to the online advertisement, within the predetermined period of time after the online activity with regard to the online advertisement, and prior to a predetermined date certain (so long as there are no other ad link criteria to be satisfied).

If the ad link criteria has been satisfied, a determination can be made that the user should be awarded an incentive. Further, a determination can be made as to the type and/or the amount of the incentive, where such determination can be based on certain incentive criteria, such as the type of offline activity performed by the user and/or an amount of time that has elapsed between the user online activity and the user offline activity, for example. In addition, the type of activity performed by the user can be compared to a list of activities that can be referenced by the ad component 102 where each activity can have a particular incentive respectively associated therewith to determine a particular incentive that can be awarded, if the user is otherwise qualified to be awarded an incentive. The incentive awarded to the user can be in virtually any form, such as, for example, the incentive can be monetary, points, coupons, awards, products, services, and/or other compensation or remuneration. At this point, methodology 500 can end.

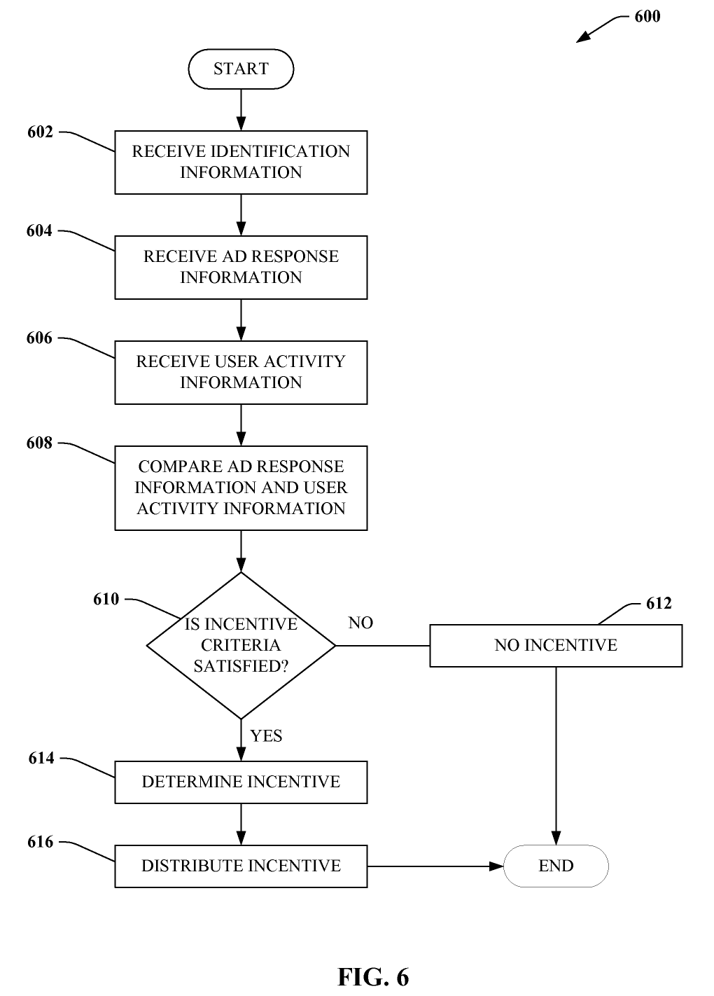

Referring to FIG. 6, a methodology 600 for facilitating associating an activity with an online advertisement is illustrated. In accordance with methodology 600, response information associated with an online advertisement and/or user activity information can be utilized to facilitate determining whether an activity performed by a user can be associated with an online advertisement. At 602, identification information of a user can be received by the ad component 102. The user can be pre-registered with a community network comprising an ad network, for example. The ad component 102, which can be associated with the community network, can receive the identification information (e.g., authentication information) when the user logs into the community network.

At 604, advertisement response information can be received by the ad component 102. For example, a response to a particular online advertisement can be in the form of viewing the online advertisement, manipulating (e.g., clicking on) an object associated with the online advertisement, and/or pledging interest in the online advertisement, which can be located on a web site, in a web page, blog, e-mail, instant message, and/or other online electronic communication; and/or generating or receiving a token (e.g., token number) associated with such online advertisement. When a user responds to the particular online advertisement, for example, in one of the above-mentioned ways, the ad component 102 can receive such response information, which can be stored in a data store 206, for example.

At 606, user activity information can be received by the ad component 102. For example, user activity information can include information relating to virtually any activity that an advertiser and/or advertising network desires to be performed by a user based on or in response to the online advertisement. The user activity and user activity information can include such activity and information described herein, for example, with regard to system 100 and/or methodology 500.

At 608, a comparison can be made of the advertising response information associated with the user and the user activity information associated with the user. For example, a comparison can be made as to the time the advertising response was made and the time of the user activity. Further, the type of activity performed by the user can be compared to a list of activities where each activity can have a particular incentive respectively associated therewith to determine a particular incentive that can be awarded, if the user is otherwise qualified to be awarded an incentive.

The comparison can be made to facilitate a determination at 610 as to whether the ad link criteria associated with the advertisement has been satisfied. For example, one ad link criteria can be that the user activity occur after the time of advertising response. If the advertising response was not made prior to the user activity, the user activity can be deemed as not being associated with the online advertisement, since the ad component 102 can infer that the user had not observed the advertisement prior to the activity of the user. Another ad link criteria can be that the user activity occur within a certain period of time (e.g., one week, 30 days, 60 days, etc.) after the time of the advertising response. User activity occurring outside of such period of time can be deemed by the ad component 102 as not being associated with the online advertisement. If the user activity occurs after the time of the response to the online advertisement and within the specified certain period of time after the response to the online advertisement, the user activity can be considered to have been activity taken in response to the online advertisement, and the user activity can be associated with the online advertisement.

At 610, if it is determined that the ad link criteria is not satisfied, such as, for example, if the user activity occurred either before the time of the response to the online advertisement by the user or occurred at a time outside of a specified certain period of time after an online advertisement response, the user activity can be determined to not be associated with the online advertisement. In such instance, at 612, no incentive is provided to the user.

If, however, at 610, it is determined that the ad link criteria has been satisfied, the user activity can be determined to be associated with the advertisement. In such instance, at 614, a determination can be made that the user should be awarded an incentive. Further, a determination can be made as to the type and/or the amount of the incentive, where such determination can be based on, for example, incentive criteria, such as the type of offline activity performed by the user and/or an amount of time that has elapsed between the user online activity and the user offline activity. The incentive can be in virtually any form, such as, for example, monetary, points, coupons, awards, products, services, and/or other compensation or remuneration.

As further example, different incentives can be presented to the user based on the type of activity the user performed. For example, a purchase of a product or service by the user can result in the user being given a higher valued incentive (e.g., higher valued in type and/or amount) than if the user takes part in a free trial for such product or service. The higher valued incentive may be presenting the user with money, instead of purchase points, or a higher number of purchase points, than the amount of purchase points which may be awarded if the user takes part in the free trial, for example.

As another example, the amount and/or type of incentive awarded to the user can be based on the length of time between viewing the online advertisement and performing the desired activity. For example, a user can be given a higher valued incentive if the user performs the desired activity, within ten days of viewing the online advertisement than if the user performs the activity after the ten-day period, even though the user may still be eligible to receive a lesser valued award after the ten-day period so long as the activity is performed before the predetermined period of time expires.

At 616, an incentive, as determined at 614, can be provided to the user. At this point, methodology 600 can end.

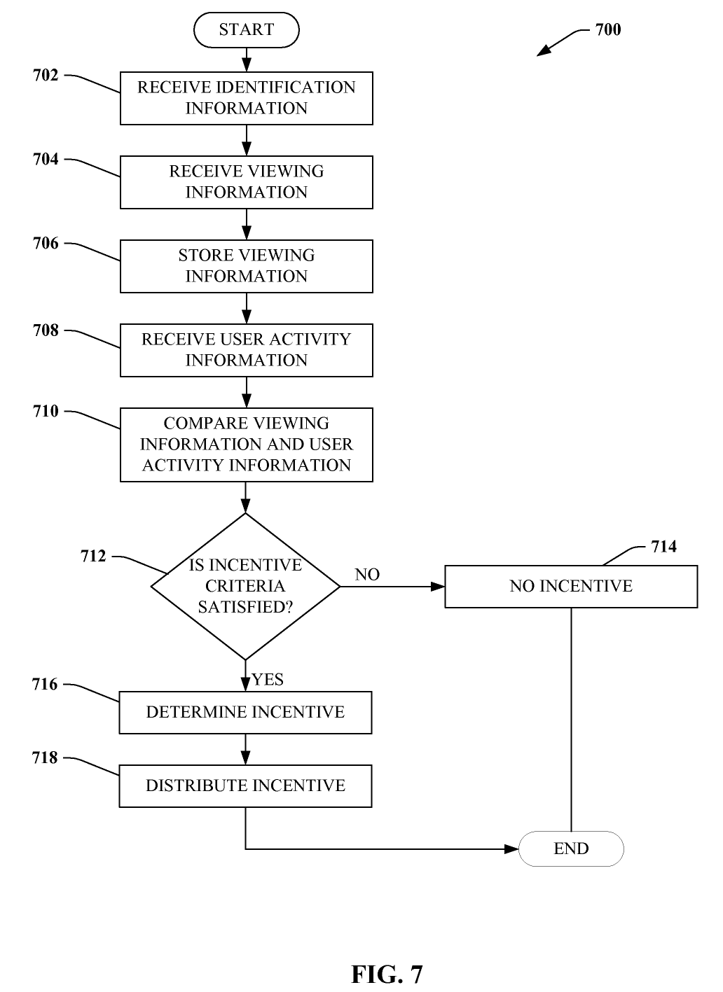

FIG. 7 illustrates a methodology 700 that can utilize online viewing information to facilitate associating user activity with an online advertisement in accordance with an embodiment of the disclosed subject matter. At 702, identification information (e.g., authentication information) of a user can be received by the ad component 102. The user can be pre-registered and have an account associated with an community network, for example. The ad component 102, which can be associated with the community network, can receive the identification information when the user logs into the network. At 704, information regarding one or more online advertisements that the user has viewed while logged on to the network can be received by the ad component 102. The online advertisement(s) can be viewed on a web site, blog, be contained in an e-mail or instant message, or be located in virtually any online electronic communication, for example. The ad-impression can be stored in a browser cookie, for example, which can be received and identified by the ad component 102 as an online advertisement that has been viewed by the user, and such information can be stored in an account of the user.

At 706, information associated with the online advertisement(s) viewed by the user can be stored in a data store (e.g., 204). For example, such information can be stored in the account 206 of the user that can be stored in the data store 204.

At 708, user activity information can be received by the ad component 102. For example, user activity information can include information regarding virtually any activity that an advertiser and/or ad network desires to be performed by a user based on or in response to the online advertisement. The user activities and user activity information can be such as that described herein, for example, with regard to system 100 and/or methodology 500.

At 710, a comparison can be made of the online advertisement viewing information associated with the user and the user activity information associated with the user. For example, a comparison can be made as to the time the online advertisement was made and the time of the user activity. Further, the type of activity performed by the user can be compared to a list of activities where each activity can have a particular incentive respectively associated therewith to determine a particular incentive that can be awarded, if the user is otherwise qualified to be awarded an incentive.

The comparison can be made to facilitate a determination at 712 as to whether the ad link criteria associated with the online advertisement has been satisfied. The ad link criteria can comprise such ad link criteria as described herein, for example, with regard to system 100 and methodology 600, for example.

At 712, if it is determined that the ad link criteria is not satisfied, the user activity can be determined to not be associated with the advertisement. In such instance, at 714, no incentive is provided to the user.

If, however, at 712, it is determined that the ad link criteria has been satisfied, the user activity can be determined to be associated with the online advertisement. In such instance, at 716, a determination can be made as to the type and/or amount of incentive to be awarded to the user. Such incentive can be in virtually any form, such as, for example, the incentive can be monetary, points, coupons, awards, products, services, and/or other compensation or remuneration. Different incentives can be presented to the user based on incentive criteria, such as the type of activity the user performed and/or the time the activity was performed, such as more fully described herein, for example, with regard to methodology 600.

Once the amount and/or type of incentive is determined at 716, at 718, the appropriate incentive can be provided to the user. The incentive can be provided to the user by depositing such incentive into the account (e.g., 206) of the user. Once the incentive is deposited to the account of the user, it can be provided to the user in virtually any suitable manner, such as allowing the user to retrieve the incentive from the account, directing a merchant to provide the incentive to the user, facilitating the mailing of such incentive to the user, etc. At this point, methodology 700 can end.

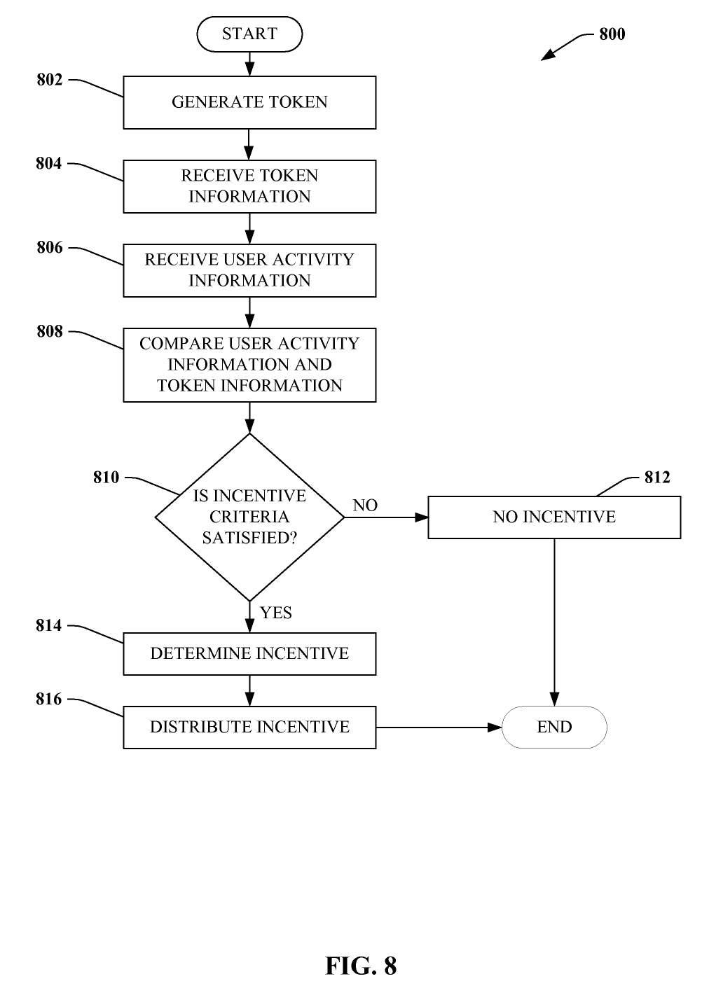

Turning to FIG. 8, a methodology 800 that can utilize token information to facilitate associating user activity with an online advertisement is depicted in accordance with another embodiment of the disclosed subject matter. At 802, a token associated with an online advertisement can be generated. For example, a user can view an online advertisement, and if interested in the product or service advertised, the user can print out a token generated by the ad network associated with the community network. The token can be generated, for example, in response to a manipulation (e.g., mouse click, keyboard stroke, voice command) associated with an object that can be associated with an online advertisement located in the web site, web page, blog, e-mail or other electronic communication, for example. The token can include a number or other information that can identify the online advertisement, the time the token was generated, the user, and/or the account associated with the user, for example.

In accordance with one aspect of the disclosed subject matter, the user can be logged in to, and/or identified by, the ad component 102 and/or the community network when the token is generated. The account information of the user can be included in the generated token. In accordance with another aspect of the disclosed subject matter, even if the user is not logged onto the community network (e.g., ad network), the user can view the online advertisement and a token can be generated. When the user performs the desired activity, the merchant can have the user provide his/her account information to the merchant, so the token can be associated with the user, who can be identified by his/her account information.

At 804, information associated with the token can be received by the ad component 102. The information with the token can be received by the ad component 102 when the user purchases and/or performs some other activity and presents the token to a merchant. The merchant can then present the token and/or information associated therewith, to the ad component 102 which can receive the token and/or associated information. If the token information does not include user account information, which may occur if the user was not logged onto and/or identified by the community network when the token was generated, for example, the merchant can also request the account information of the user, and such account information can be received by the ad component 102 at the time the activity it completed by the user.

At 806, user activity information can be received by the ad component 102. The user activity can be received by the ad component 102 from a merchant, for example. The user activity information can include information regarding virtually any activity (e.g., purchase, sampling of a product or service, filling out a registration, etc.) that an advertiser and/or ad network desires to be performed by a user based on or in response to the online advertisement, such as that described herein, for example, with regard to system 100 and/or methodology 500.

At 808, a comparison can be made of the information associated with the token and the user activity information associated with the user. For example, a comparison can be made regarding the online advertisement associated with the token and the particular activity performed by the user. Also, a comparison can be made as to the time the token was generated and the time of the user activity. Further, the type of activity performed by the user can be compared to a list of activities where each activity can have a particular incentive respectively associated therewith to determine a particular incentive that can be awarded, if the user is otherwise qualified to be awarded an incentive.

The comparison at 808 can be made to facilitate a determination at 810 as to whether the ad link criteria associated with the online advertisement has been satisfied. For example, one ad link criteria can be that the user activity occur after the time of viewing the online advertisement. If the token was not generated prior to the user activity (e.g., if the user is generated and presented a token to the merchant after the activity has been completed), the user activity can be deemed as not being associated with the online advertisement, since the ad component 102 can determine and/or infer that the user had not observed the online advertisement and generated a token prior to the activity of the user. Another ad link criteria can be that the user activity occur within a certain period of time after the token is generated. User activity occurring outside of such period of time can be deemed by the ad component 102 as not being associated with the online advertisement. If the user activity occurs after the time of the generating the token and within a pre-determined period of time after the token is generated, the user activity can be considered to have been in response to the online advertisement, and the user activity can be associated with the online advertisement.

At 810, if it is determined that the ad link criteria is not satisfied, such as, for example, if the user activity occurred either before the time of the token was generated or occurred at a time outside of a predetermined period of time after the token was generated, the user activity can be determined to not be associated with the online advertisement. In such instance, at 812, no incentive is provided to the user. If, however, at 810, it is determined that the ad link criteria has been satisfied, such as, for example, the user activity occurred after the time the token was generated and within the predetermined period of time to perform the activity after the token was generated, the user activity can be determined to be associated with the online advertisement. In such instance, at 814, a determination can be made as to the type and amount of incentive to be awarded to the user. Different incentives can be presented to the user based on certain incentive criteria, such as the type of activity the user performed and/or the time the activity was performed, such as more fully described herein, for example, with regard to methodology 600.

Once the amount and/or type of incentive is determined at 814, at 816, the appropriate incentive can be provided to the user. Such incentive can be in virtually any form, such as, for example, monetary, points, coupons, awards, products, services, and/or other compensation or remuneration. The incentive can be provided to the user by depositing such incentive into the account (e.g., 206) of the user. Once the incentive is deposited to the account of the user, it can be provided to the user in virtually any suitable manner, such as allowing the user to retrieve the incentive from the account, directing a merchant to provide the incentive to the user, facilitating the mailing of such incentive to the user, etc. At this point, methodology 800 can end.

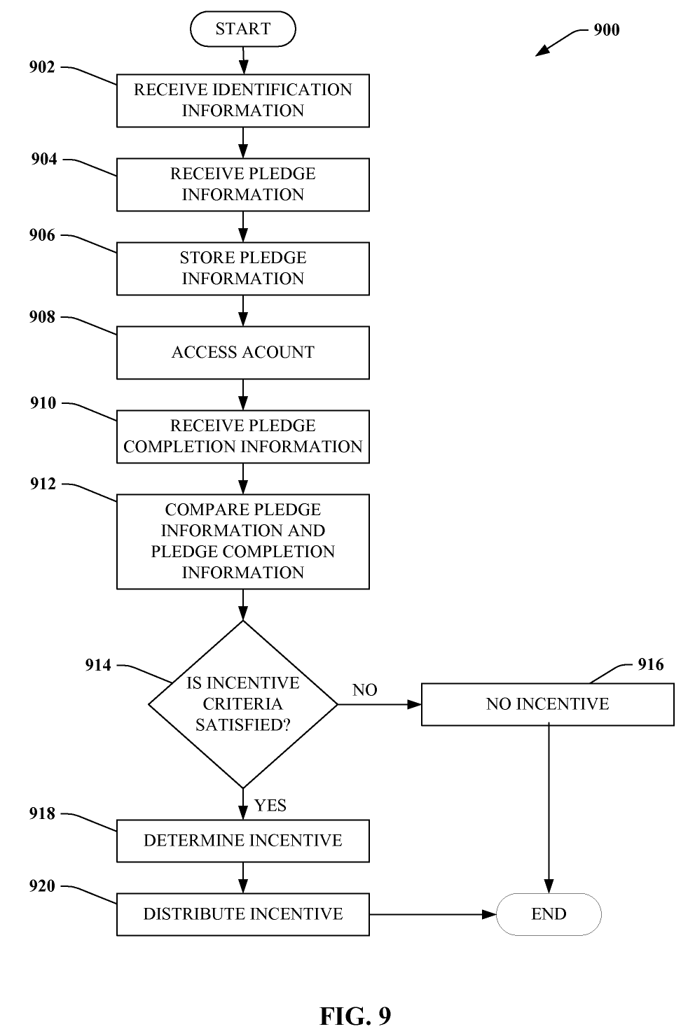

Referring to FIG. 9, illustrated is a methodology 900 that utilizes pledge information to facilitate associating user activity with an online advertisement in accordance with yet another embodiment of the disclosed subject matter. At 902, identification information (e.g. authentication information) of a user can be received by the ad component 102. The user can be pre-registered and have an account associated with a community network associated with the ad component 102, for example. The ad component 102 can receive the identification information when the user logs into the community network. At 904, information regarding a pledge of interest as to an online advertisement(s) by the user can be received by the ad component 102. The online advertisement can be an online advertisement viewed on a web site, blog, an e-mail or instant message, or be located in virtually any online electronic communication, for example. The pledge information can include information that identifies the user and/or user account, information regarding the online advertisement, and/or information regarding the time of the pledge, for example.

At 906, pledge information associated with the online advertisement(s) can be stored in a data store 204. For example, such information can be stored in the account 206 of the user that can be stored in the data store 204. At 908, the user account 206 can be accessed by the ad component 102. For example, the user account 206 can be accessed when the user has performed or is performing an activity desired by the ad network, associated with the community network, with regard to the online advertisement. The user can present the merchant with the account information of the user, and the merchant can provide such information to the ad component 102, so that the user account 206 can be accessed.

At 910, information indicating that the pledge has been completed can be received by the ad component 102. For example, when the user performs the activity desired by the ad network with regard to the online advertisement, the ad component 102 can receive information from the merchant indicating that the pledge of the user has been completed. The received pledge completion information can include information regarding the identity of the user and/or user account information, information regarding the online advertisement, and/or information regarding the time that the pledge was completed, for example. The pledge information also can include user activity information. The user activity information can include virtually any activity that an advertiser and/or ad network desires to be performed by a user based on or in response to the online advertisement, such as that more fully described herein, for example, with regard to system 100 and/or methodology 600.

At 912, a comparison can be made of the pledge completion information and the pledge information, associated with the user. For example, the ad component 102 can facilitate comparing the time the pledge was made by the user and the time of the pledge was completed as a result of the user performing the desired activity. Further, the type of activity performed by the user can be compared to a list of activities where each activity can have a particular incentive respectively associated therewith to determine a particular incentive that can be awarded, if the user is otherwise qualified to be awarded an incentive.

The comparison can be made to facilitate a determination at 914 as to whether the ad link criteria associated with the online advertisement has been satisfied. For example, one ad link criteria can be that the pledge completion (e.g., performance of the activity by the user) occur after the particular time the user makes a pledge of interest with regard to the online advertisement. If the user has not pledged an interest with regard to the online advertisement, no pledge will be stored in the account of the user, so there will be no pledge in the user account to indicate as complete.

Another ad link criteria can be that the completion of the pledge occur within a certain period of time (e.g., one week, 30 days, 60 days, etc.) after the time of pledging an interest with regard to the online advertisement. Completion of the pledge that occurs outside of such period of time can be deemed by the ad network as not being associated with the online advertisement. In accordance with an aspect of the disclosed subject matter, a pledge of interest can be automatically deleted from the user account or otherwise automatically become expired after a predetermined amount of time after the pledge of interest is made by the user. Such action to remove or de-activate the pledge from the user account can be taken by the ad network or other entity administering the account of the user, for example.

Further, if the pledge of interest with regard to the online advertisement was not made prior to the pledge completion (e.g., user activity), the user activity can be deemed as not being associated with the online advertisement, since the ad component 102 can infer that the user had not observed the online advertisement prior to the activity of the user. In such case, no pledge will appear in the account of the user, so long as the pledge completion information is received by the ad component 102 at approximately the same time as the user activity.

The ad link criteria can be satisfied, for example, if information regarding the completion of the pledge and/or user activity is received after the time of information regarding the pledge of interest is received by the ad component 102 and within a pre-determined period of time after such pledge is received.

At 914, if it is determined that the ad link criteria is not satisfied, the user activity can be determined to not be associated with the advertisement. In such instance, at 916, no incentive is provided to the user.

If, however, at 914, it is determined that the ad link criteria has been satisfied, the user activity can be determined to be associated with the online advertisement. In such instance, at 918, a determination can be made as to the type and/or amount of incentive to be awarded to the user. Such incentive can be in virtually any form, such as, for example, monetary, points, coupons, awards, products, services, and/or other compensation or remuneration. Different incentives can be presented to the user based on certain incentive criteria, such as the type of activity the user performed and/or the time the activity was performed, such as more fully described herein, for example, with regard to methodology 600.

Once the amount and/or type of incentive has been determined at 918, at 920, the appropriate incentive can be provided to the user. The incentive can be provided to the user by depositing such incentive into the account 206 of the user. Once the incentive is deposited to the user account 206, it can be provided to the user in virtually any suitable manner, such as allowing the user to retrieve the incentive from the account, directing a merchant to provide the incentive to the user, facilitating the mailing of such incentive to the user, etc. At this point, methodology 900 can end.

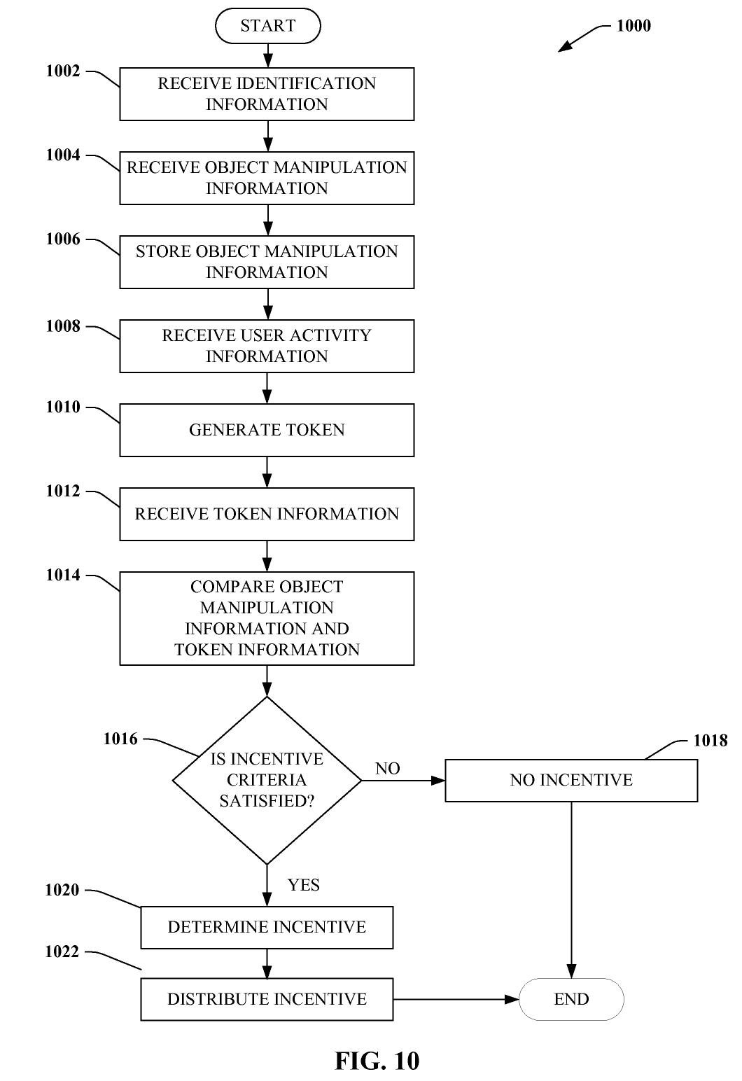

FIG. 10 illustrates a methodology 1000 that utilizes token information and/or click information to facilitate associating user activity with an online advertisement in accordance with still another embodiment of the disclosed subject matter. At 1002, identification information (e.g., authentication information) of a user can be received by the ad component 102. The user can be pre-registered and have an account associated with a community network comprising an ad network, for example. The ad component 102 can be associated with the community network and can receive the identification information when the user logs into the community network.

At 1004, object manipulation information (e.g., mouse click, keystroke, voice command) with regard to an online advertisement can be received by the advertising network. The object manipulation information can be associated with an object in the online advertisement, for example, where clicking on the object can indicate to the ad component 102 that the user has observed and/or is interested in the online advertisement. The online advertisement can be an advertisement viewed on a web site, blog, an e-mail or instant message, or be located in virtually any online electronic communication, for example. The object manipulation information can include information that identifies the user and/or user account, information regarding the online advertisement, and/or information regarding the time of the manipulation, for example.

At 1006, object manipulation information associated with the online advertisement(s) can be stored in a data store 204. For example, such information can be stored in the account 206 of the user where such account 206 can be stored in the data store 204. At 1008, user activity information can be received by the ad component 102. The user activity can be received by the ad component 102 from a merchant, for example. The user activity information can include information associated with virtually any activity that an advertiser and/or ad network desires to be performed by a user based on or in response to the online advertisement, such as that more fully described herein, for example, with regard to system 100 and/or methodology 600.

At 1010, a token associated with an online advertisement can be generated. For example, when the user performs the desired activity, a token can be generated by the ad component 102 when the merchant indicates that the activity has been performed by the user. The merchant can print out the token generated by the ad network and can provide the token to the user. For example, the token can be printed on a receipt relating to the activity, and the receipt can be provided to the user. The token can include information, such as a number and/or other information that can identify the online advertisement, the time the token was generated, the user activity, the user, and/or the account associated with the user, for example.

At 1012, information associated with the token can be received by the ad component 102. For example, the user can log in to his/her account 206. The user can present the token information to the ad component 102, and the ad component 102 can receive such information. The token information can be in the form of numbers, letters, and/or other characters, for example.

At 1014, a comparison can be made of the object manipulation information and the token information and/or user activity information, associated with the user. For example, the ad network can facilitate comparing the time the object manipulation was made by the user and the time of the token was generated as a result of the user performing the desired activity. Further, the type of activity performed by the user can be compared to a list of activities where each activity can have a particular incentive respectively associated therewith to determine a particular incentive that can be awarded, if the user is otherwise qualified to be awarded an incentive.

The comparison can be made to facilitate a determination at 1016 as to whether the ad link criteria associated with the online advertisement has been satisfied. For example, one ad link criteria can be that the token be generated after the particular time the object manipulation information with regard to the online advertisement is received by the ad component 102.

Another ad link criteria can be that the token be generated and/or token information received by the ad component 102 within a predetermined period of time after the time the object manipulation information with regard to the online advertisement is received by the ad component 102. A token that is generated and/or token information received by the ad component 102 outside of such period of time can be deemed by the ad component 102 as not being associated with the online advertisement. In accordance with an aspect of the disclosed subject matter, object manipulation information regarding an online advertisement can be automatically deleted from the user account 206 or otherwise automatically become expired after a predetermined period of time after the click information is received by the ad component 102. Such action to remove or de-activate the object manipulation information from the user account 206 can be taken by the ad component 102 or other entity administering the account of the user, for example.

Further, if the object manipulation information with regard to the online advertisement was not made prior to the generation of the token, the user activity can be deemed as not being associated with the online advertisement, since the ad component 102 can infer that the user had not observed the online advertisement prior to the activity of the user.

User activity can be associated with the online advertisement, if the token information identifies that the user activity occurred after the time the object manipulation information is received by the ad component 102 and within a pre-determined period of time after such pledge is received. In such instance, the user activity can be associated with the online advertisement.

At 1016, the user activity can be determined to not be associated with the online advertisement, if it is determined that the ad link criteria is not satisfied. In such instance, at 1018, no incentive is provided to the user.

If, however, at 1016, it is determined that the ad link criteria has been satisfied, the user activity can be determined to be associated with the online advertisement. In such instance, at 1020, a determination can be made as to the type and/or amount of incentive to be awarded to the user. Such incentive can be in virtually any form, such as, for example, monetary, points, coupons, awards, products, services, and/or other compensation or remuneration. Different incentives can be presented to the user based on incentive criteria such as the type of activity the user performed and/or the time the activity was performed, such as more fully described herein, for example, with regard to methodology 600.

Once the amount and/or type of incentive has been determined at 1020, at 1022, the appropriate incentive can be provided to the user. The incentive can be provided to the user by depositing such incentive into the account 206 of the user. Once the incentive is deposited to the user account 206, it can be provided to the user in virtually any suitable manner, such as allowing the user to retrieve the incentive from the account, directing a merchant to provide the incentive to the user, facilitating the mailing of such incentive to the user, etc. At this point, methodology 1000 can end.

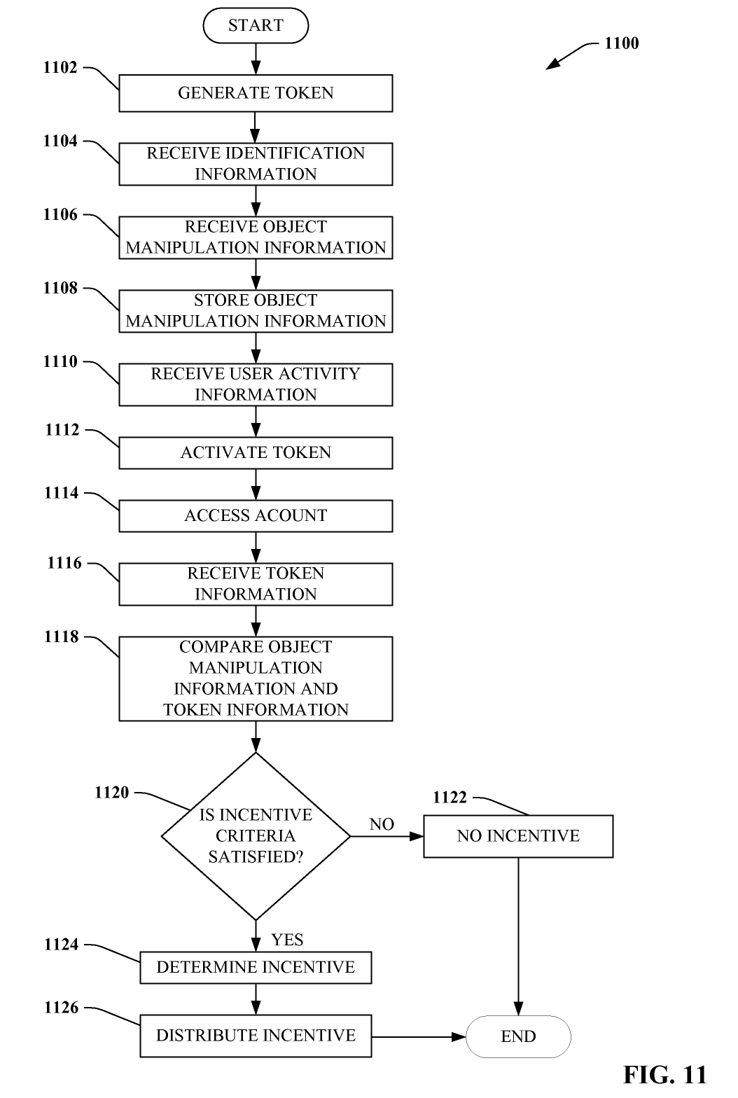

Turning to FIG. 11, another methodology 1100 that utilizes token information and/or object manipulation information to facilitate associating user activity with an online advertisement in accordance with an embodiment of the disclosed subject matter is depicted. At 1 102, a token associated with an online advertisement can be generated. The token can include a number and/or other information that can identify the online advertisement to which it relates, the time the token was generated, and/or the type(s) of activity(ies) desired to be performed by the user, for example. The token can be pre-generated (e.g., pre-printed) and can be provided to a merchant, for example.

At 1104, identification information (e.g., authentication information) of the user can be received by the ad component 102. The user can be pre-registered and have an account 206 associated with a community network comprising an ad network, for example. The ad component 102 can be associated with the community network and can receive the identification information when the user logs into the community network.

At 1106, object manipulation information (e.g., mouse click, keystroke, voice command) with regard to an online advertisement can be received by the ad component 102. The object manipulation information can be associated with an object in the online advertisement, for example, where clicking on the object can indicate to the ad component 102 that the user has observed and/or is interested in the online advertisement. The online advertisement can be an advertisement viewed on a web site, blog, an e-mail or instant message, or be located in virtually any online electronic communication, for example. The object manipulation information can include information that identifies the user and/or user account, information regarding the online advertisement, and/or information regarding the time of the object manipulation, for example.

At 1108, the received object manipulation information associated with the online advertisement(s) can be stored in a data store 204. For example, such information can be stored in the account 206 associated with the user where such account can be stored in the data store 204.

At 1110, user activity information can be received by the ad component 102. The user activity can be received by the ad component 102 from a merchant, for example. The user activity information can include information regarding virtually any activity that an advertiser and/or ad network desires to be performed by a user based on or in response to the online advertisement, as more fully described herein, for example, with regard to system 100 and/or methodology 600.

At 1112, the token, previously generated, can be activated. For example, the merchant can have the token prior to the time when the user performs the desired activity, and, the token can be activated by the merchant after the user performs the desired activity related to a product, service, etc., that can be related to the online advertisement.

At 1114, the account of the user can be accessed. For example, the user can provide his/her registration information to the ad component 102, and the ad component 102 can access the respective user account 206, and can also allow the user to access his/her account 206. At 1116, information associated with the token can be received by the ad component 102. For example, the ad component 102 can receive such token information from the user. The token information can be in the form of numbers, letters, and/or other characters, for example.

At 1118, a comparison can be made of the object manipulation information and the token information, associated with the user. For example, the ad component 102 can facilitate comparing the time the object manipulation was made by the user and the time the token was activated as a result of the user performing the desired activity. Further, from the token activation information, the ad component 102 can facilitate comparing the type of activity performed by the user can be compared to a list of activities where each activity can have a particular incentive respectively associated therewith to determine a particular incentive that can be awarded, if the user is otherwise qualified to be awarded an incentive.

The comparison can be made to facilitate a determination at 1120 as to whether the ad link criteria associated with the online advertisement has been satisfied. For example, one ad link criteria can be that the token be activated after the particular time the click information with regard to the online advertisement is received by the ad network.

Another ad link criteria can be that the token be activated within a predetermined period of time after the time the object manipulation information regarding the online advertisement is received by the ad component 102. A token that is activated at a time that is outside of such predetermined period of time can be deemed by the ad component 102 as not being associated with the online advertisement. In accordance with an aspect of the disclosed subject matter, object manipulation information regarding an online advertisement can be automatically deleted from the user account or otherwise automatically become expired after such predetermined period of time has expired. Such action to remove or de-activate the object manipulation information from the user account can be taken by the ad component 102 or other entity administering the account of the user, for example.

Further, if the object manipulation information with regard to the online advertisement was not made prior to the activation of the token, the user activity can be deemed as not being associated with the online advertisement, since the ad component 102 and/or component (e.g., intelligent component) associated therewith can infer that the user had not observed the online advertisement prior to the activity of the user.

User activity can be associated with the online advertisement, if the token activation information identifies that the token was activated, and thus the user activity occurred, after the time the click information is received by the ad component 102 and within a pre-determined period of time after the object manipulation information was received by the ad component 102. In such instance, the user activity can be associated with the online advertisement.

At 1120, the user activity can be determined to not be associated with the online advertisement, if it is determined that the ad link criteria is not satisfied. In such instance, at 1122, no incentive is provided to the user.

If, however, at 1120, it is determined that the ad link criteria has been satisfied, the user activity can be determined to be associated with the online advertisement. In such instance, at 1 124, a determination can be made as to the type and/or amount of incentive to be awarded to the user. Such incentive can be in virtually any form, such as, for example, the incentive can be monetary, points, coupons, awards, products, services, and/or other compensation or remuneration. Different incentives can be presented to the user based on certain incentive criteria such as the type of activity the user performed and/or the time the activity was performed by the user, as more fully described, for example, with regard to system 100 and/or methodology 600.

For example, a purchase of a product or service by the user can result in the user being given a higher valued incentive than if the user takes part in a free trial for such product or service. The higher valued incentive may be presenting the user with money, instead of purchase points, or a higher number of purchase points, than the amount of purchase points which may be awarded if the user takes part in the free trial, for example.

As another example, the amount and/or type of incentive awarded to the user can be based on the length of time between the ad component 102 receiving the object manipulation information and the time of activation of the token, which can indicate the completion of the desired activity related to the online advertisement. For example, a user can be given a higher valued incentive if the token activation information indicates that the user has completed the activity within a certain period of time (that can be shorter than the predetermined period of time) than if such token activation information indicates that the activity was performed by the user outside of the certain period of time, even though the user may still be eligible to receive a lesser valued award after the certain period of time so long as the token activation information is received before the predetermined period of time expires and/or indicates that the activity was completed before the predetermined period of time expires.

Once the amount and/or type of incentive has been determined at 1124, at 1126, the appropriate incentive can be provided to the user. The incentive can be provided to the user by depositing such incentive into the account 206 of the user. Once the incentive is deposited to the user account 206, it can be provided to the user in virtually any suitable manner, such as allowing the user to retrieve the incentive from the account, directing a merchant to provide the incentive to the user, facilitating the mailing of such incentive to the user, etc. At this point, methodology 1100 can end.

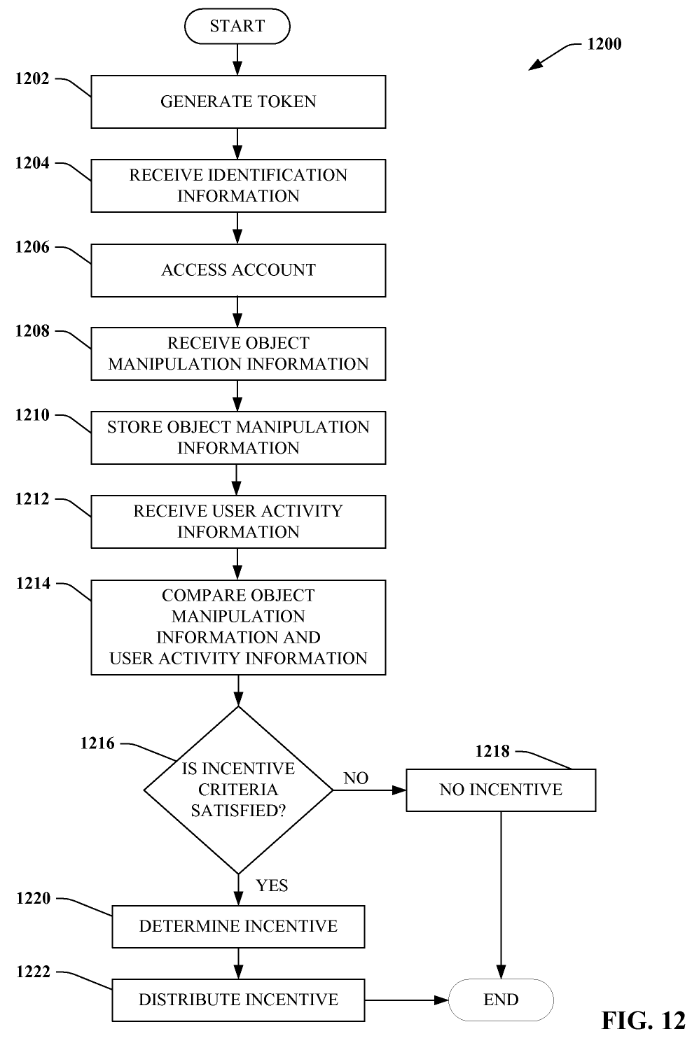

FIG. 12 illustrates yet another methodology 1200 that can utilize token information and /or object manipulation information to facilitate associating user activity with an online advertisement in accordance with another embodiment of the disclosed subject matter. At 1202, a token associated with an online advertisement can be generated. The token can include a number and/or other information that can identify the online advertisement to which it relates, the time the token was generated, and/or the type(s) of activity(ies) desired to be performed by the user, for example. The token can be inserted in a product (e.g., cereal box, compact disc (CD) case, etc.) or can be mass mailed to persons and entities, for example. When a user engages in an offline activity, such as when the user purchases or otherwise receives the product and/or receives the mailing, the user can retrieve the token from the product container and/or mailing.

At 1204, identification information of the user can be received by the ad component 102 when the user logs into the community network that can be associated therewith and can comprise an ad network. The user can be pre-registered and have an account 206 associated with the community network, for example. At 1206, the account 206 of the user can be accessed by the ad component 102 (and the user) upon receiving the identification of the user.

At 1208, object manipulation information (e.g., mouse click, keystroke) with regard to an online advertisement can be received by the ad component 102. The object manipulation information can be associated with an object in the online advertisement, for example, where clicking on the object can indicate to the ad component 102 that the user has observed and/or is interested in the online advertisement. The online advertisement can be an advertisement viewed on a web site, blog, an e-mail or instant message, or be located in virtually any online electronic communication, for example. The object manipulation information can include information that identifies the user and/or user account 206, information regarding the online advertisement, and/or information regarding the time of the object manipulation, for example.

At 1210, the received object manipulation information associated with the online advertisement(s) can be stored in a data store 204. For example, such information can be stored in the account 206 associated with the user where such account 206 can be stored in the data store 204.

At 1212, user activity information can be received by the ad component 102. The user activity information can include the token information from the token generated at 1202. The ad component 102 can receive the token information from the user, such as by the user inputting token information contained thereon into a keyboard, keypad, and/or mouse clicks, for example. The token information can be in the form of numbers, letters, and/or other characters, for example. The token information also can include information regarding the type of product or mailing; a time the token, the product, and/or mailing was created; and/or the location where the token was obtained by the user, for example. The user activity information can include information regarding the time the token information was received by the ad component 102 as well.

At 1214, a comparison can be made of the object manipulation information and the user activity information, including the token information, associated with the user. For example, the ad component 102 can facilitate comparing the online advertisement associated with the object manipulation that was made by the user and the user activity information, for example, to ascertain whether the token relates to the online advertisement. Further, from the token information, the ad component 102 can facilitate comparing the type of activity performed by the user to a list of activities where each activity can have a particular incentive respectively associated therewith to determine a particular incentive that can be awarded, if the user is otherwise qualified to be awarded an incentive.

The comparison can be made to facilitate a determination at 1216 as to whether the ad link criteria associated with the online advertisement has been satisfied. For example, as stated, one ad link criteria can be that the token pertain to the online advertisement. User activity information involving a token that does not pertain to the online advertisement (e.g., token relates to a product or service that is not marketed by the online advertisement) can be deemed by the ad component 102 as not associated with the online advertisement.

Another ad link criteria can be that the token information be received by the ad component 102 by a predetermined time. Token information that is received at a time after the predetermined time (e.g., deadline) can be deemed by the ad component 102 as not being associated with the online advertisement.

User activity can be associated with the online advertisement, if the user activity information (e.g., token information) received by the ad component 102 relates to the online advertisement and was received prior to the deadline for submitting such information to the ad component. In such instance, the user activity can be considered to be associated with the online advertisement.

Thus, at 1216, the user activity can be determined to not be associated with the online advertisement, if it is determined that the ad link criteria is not satisfied. In such instance, at 1218, no incentive is provided to the user.

If, however, at 1216, it is determined that the ad link criteria has been satisfied, the user activity can be determined to be associated with the online advertisement. In such instance, at 1220, a determination can be made as to the type and/or amount of incentive to be awarded to the user. Such incentive can be in virtually any form, such as, for example, monetary, points, coupons, awards, products, services, and/or other compensation or remuneration. Different incentives can be presented to the user based on certain incentive criteria such as the type of activity the user performed and/or the time the activity was performed by the user, as more fully described herein, for example, with regard to methodology 600.

Once the amount and/or type of incentive has been determined at 1220, at 1222, the appropriate incentive can be provided to the user. The incentive can be provided to the user by depositing such incentive into the account 206 of the user. Once the incentive is deposited to the user account 206, it can be provided to the user in virtually any suitable manner, such as allowing the user to retrieve the incentive from the account 206, directing a merchant to provide the incentive to the user, facilitating the mailing of such incentive to the user, etc. At this point, methodology 1200 can end.

It should be appreciated that the methodologies disclosed herein and throughout this specification are capable of being stored on an article of manufacture to facilitate transporting and transferring such methodologies to computers. The term article of manufacture, as used herein, is intended to encompass a computer program accessible from any computer-readable device, carrier, or media.

It should also be appreciated that some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

Further, it has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

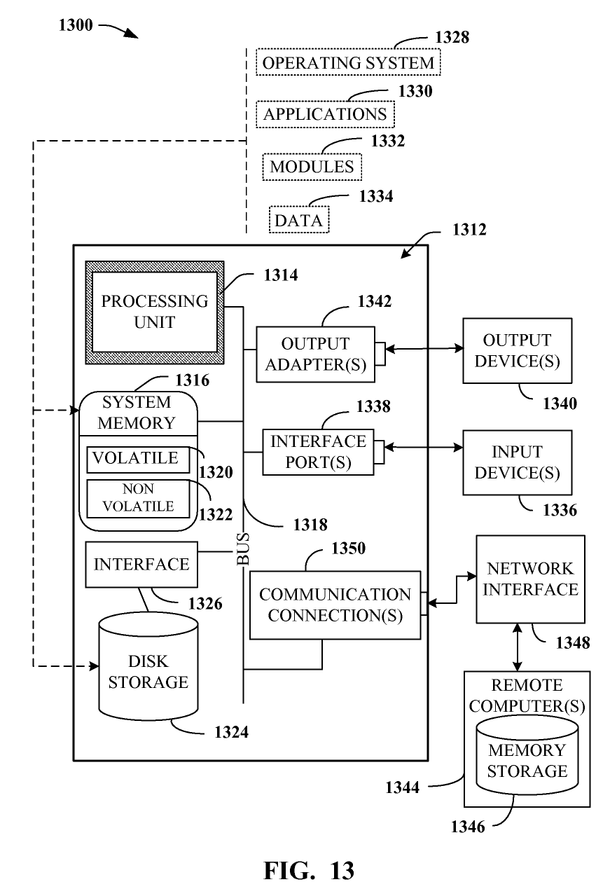

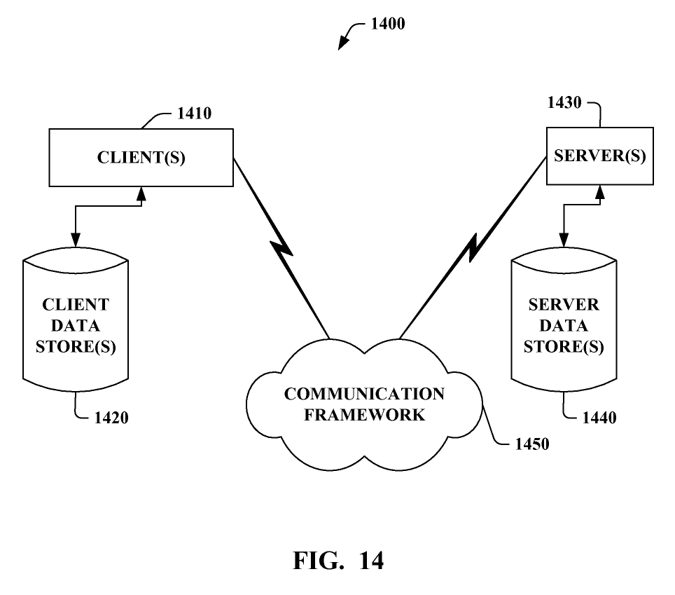

In order to provide a context for the various aspects of the disclosed subject matter, FIGS. 13 and 14 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

With reference to FIG. 13, a suitable environment 1300 for implementing various aspects of the claimed subject matter includes a computer 1312. The computer 1312 includes a processing unit 1314, a system memory 1316, and a system bus 13 18. The system bus 1318 couples system components including, but not limited to, the system memory 1316 to the processing unit 1314. The processing unit 1314 can be any of various available processors. Dual microprocessors and other multiprocessor architectures also can be employed as the processing unit 1314.

The system bus 1318 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1316 includes volatile memory 1320 and nonvolatile memory 1322. The basic input/output system (BIOS), containing the basic routines to transfer information between elements within the computer 1312, such as during start-up, is stored in nonvolatile memory 1322. By way of illustration, and not limitation, nonvolatile memory 1322 can include read only memory (ROM), programmable ROM (PROM), electrically programmable ROM (EPROM), electrically erasable programmable ROM (EEPROM), or flash memory. Volatile memory 1320 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1312 also includes removable/non-removable, volatile/non-volatile computer storage media. FIG. 13 illustrates, for example, a disk storage 1324. Disk storage 1324 includes, but is not limited to, devices like a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1324 to the system bus 1318, a removable or non-removable interface is typically used, such as interface 1326.

It is to be appreciated that FIG. 13 describes software that acts as an intermediary between users and the basic computer resources described in the suitable operating environment 1300. Such software includes an operating system 1328. Operating system 1328, which can be stored on disk storage 1324, acts to control and allocate resources of the computer system 1312. System applications 1330 take advantage of the management of resources by operating system 1328 through program modules 1332 and program data 1334 stored either in system memory 1316 or on disk storage 1324. It is to be appreciated that the claimed subject matter can be implemented with various operating systems or combinations of operating systems.

A user enters commands or information into the computer 1312 through input device(s) 1336. Input devices 1336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1314 through the system bus 1318 via interface port(s) 1338. Interface port(s) 1338 include, for example, a serial port, a parallel port, a game port, and a universal serial bus (USB). Output device(s) 1340 use some of the same type of ports as input device(s) 1336. Thus, for example, a USB port may be used to provide input to computer 1312, and to output information from computer 1312 to an output device 1340. Output adapter 1342 is provided to illustrate that there are some output devices 1340 like monitors, speakers, and printers, among other output devices 1340, which require special adapters. The output adapters 1342 include, by way of illustration and not limitation, video and sound cards that provide a means of connection between the output device 1340 and the system bus 1318. It should be noted that other devices and/or systems of devices provide both input and output capabilities such as remote computer(s) 1344.

Computer 1312 can operate in a networked environment using logical connections to one or more remote computers, such as remote computer(s) 1344. The remote computer(s) 1344 can be a personal computer, a server, a router, a network PC, a workstation, a microprocessor based appliance, a peer device or other common network node and the like, and typically includes many or all of the elements described relative to computer 1312. For purposes of brevity, only a memory storage device 1346 is illustrated with remote computer(s) 1344. Remote computer(s) 1344 is logically connected to computer 1312 through a network interface 1348 and then physically connected via communication connection 1350. Network interface 1348 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1350 refers to the hardware/software employed to connect the network interface 1348 to the bus 1318. While communication connection 1350 is shown for illustrative clarity inside computer 1312, it can also be external to computer 1312. The hardware/software necessary for connection to the network interface 1348 includes, for exemplary purposes only, internal and external technologies such as, modems including regular telephone grade modems, cable modems and DSL modems, ISDN adapters, and Ethernet cards.

FIG. 14 is a schematic block diagram of a sample-computing environment 1400 with which the subject innovation can interact. The system 1400 includes one or more client(s) 1410. The client(s) 1410 can be hardware and/or software (e.g., threads, processes, computing devices). The system 1400 also includes one or more server(s) 1430. Thus, system 1400 can correspond to a two-tier client server model or a multi-tier model (e.g., client, middle tier server, data server), amongst other models. The server(s) 1430 can also be hardware and/or software (e.g., threads, processes, computing devices). The servers 1430 can house threads to perform transformations by employing the subject innovation, for example. One possible communication between a client 1410 and a server 1430 may be in the form of a data packet transmitted between two or more computer processes.

The system 1400 includes a communication framework 1450 that can be employed to facilitate communications between the client(s) 1410 and the server(s) 1430. The client(s) 1410 are operatively connected to one or more client data store(s) 1420 that can be employed to store information local to the client(s) 1410. Similarly, the server(s) 1430 are operatively connected to one or more server data store(s) 1440 that can be employed to store information local to the servers 1430.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim

What is claimed is:

1. A system that determines if user activity is associated with an online advertisement, comprising:
an ad link component that receives information associated with at least one user activity and at least one online advertisement and determines if the at least one user activity is associated with the at least one online advertisement, the at least one user activity comprised of at least one offline user activity.

2. The system of claim 1, further comprising an analyzer component that can receive information associated with the at least one user activity and the at least one online advertisement, analyzes the received information, and compares the received information to a subset of ad link criteria.

3. The system of claim 2, the subset of link criteria is based on at least one of a type of user activity, a period of time to perform the user activity, a date certain, or a combination thereof.

4. The system of claim 2, the analyzer component determines at least one of a type of incentive or an amount of incentive, or a combination thereof, based on a subset of incentive criteria.

5. The system of claim 4, the subset of incentive criteria is based on at least one of a type of user activity, a period of time to perform the user activity, a date certain, or a combination thereof.

6. The system of claim 1, further comprising a distribution component that can facilitate distribution of an incentive to a user, the incentive is comprised of at least one of money, points, coupons, awards, products, or services, or a combination thereof.

7. The system of claim 1, further comprising a token component that can facilitate generation of at least one token associated with the at least on online advertisement.

8. The system of claim 1, further comprising a data store that can store information associated with the at least one of a user activity, the at least one online advertisement, a user, a client, or a merchant, an advertiser, or a combination thereof.

9. The system of claim 1, the at least one offline activity comprises at least one of a purchase, sampling of a product or service, registering for a product or service, filling out a form, or providing a review or comments regarding a product or service, or a combination thereof.

10. The system of claim 1, the at least one user activity further comprises at least one of viewing the at least one online advertisement, clicking on an object associated with the at least one online advertisement, pledging interest in the at least one online advertisement, or obtaining a token related to the at least one online advertisement, or a combination thereof.

11. The system of claim 1, further comprising an intelligent component that makes an inference as to whether the at least one user activity is linked to the at least one online advertisement.

12. The system of claim 1, the at least one online advertisement is displayed in at least one of a web site, a web page, a blog, an e-mail, or an instant message, or a combination thereof.

13. At least one computer that comprises the ad link component of claim 1.

14. A method that facilitates determining if user activity is associated with an online advertisement, comprising:
evaluating information associated with at least one of the user activity, the online advertisement, or a user, or a combination thereof; and
determining if the user activity is associated with the online advertisement based on a subset of link criteria.

15. The method of claim 14, further comprising:
comparing the information associated with at least one of the user activity, the online advertisement, or a user, or a combination thereof, with the subset of link criteria, the user activity comprising at least one of an online user activity or an offline user activity, or a combination thereof, and the subset of link criteria is based on at least one of a time for performing at least one user online activity, a time for performing at least one offline user activity, or a date certain, or a combination thereof;
distributing an incentive based on a subset of incentive criteria if the user activity is associated with the online advertisement.

16. The method of claim 14, further comprising:
receiving information associated with at least one of the user activity, the online advertisement, or a user, or a combination thereof, the at least one of the user activity comprising at least one of viewing information, click information, pledge information, token information, or a combination thereof, associated with the user.

17. The method of claim 14, further comprising:
receiving information associated with at least one of the link criteria or the subset of incentive criteria, or a combination thereof;
determining at least one of a type of incentive or an amount of incentive, or a combination thereof, based in part on the subset of incentive criteria.

18. The method of claim 14, further comprising:
generating a token;
linking the token to the online advertisement.

19. A system for linking an activity of a user with an online advertisement, comprising:
means for analyzing data associated with at least one of activity of a user or an online advertisement, or a combination thereof; and
means for determining if the activity of a user can be associated with the online advertisement based on at least one ad link criteria.

20. The system of claim 19, further comprising:
means for monitoring data associated with at least one of online activity of the user;
means for receiving data;
means for storing data;
means for generating at least one token associated with the online advertisement;
means for comparing the data associated with at least one of activity of the user or the online advertisement, or a combination thereof, with the at least one ad link criteria or one incentive criteria, or a combination thereof;
means for determining an incentive to provide the user if the at least one ad link criteria is satisfied; and
means for providing the incentive.
